(19) United States
(12) Patent Application Publication
(10) Pub. No.: US 2024/0039308 A1
(43) Pub. Date: Feb. 1, 2024

(54) BATTERY PACK

(71) Applicant: MAKITA CORPORATION, Anjo-shi, Aichi (JP)

(72) Inventors: Tomoki HORI, Anjo-shi (JP); Hayato KANO, Anjo-shi (JP)

(73) Assignee: MAKITA CORPORATION, Anjo-shi, Aichi (JP)

(21) Appl. No.: 18/267,484

(22) PCT Filed: Dec. 15, 2021
(86) PCT No.: PCT/JP2021/046382

§ 371 Date: Jun. 15, 2023

(30) Foreign Application Priority Data
Dec. 18, 2020 (JP) 2020-210606

(51) Int. Cl. H02J 7/00; H01M 10/48; H01M 50/583

(52) U.S. Cl. CPC H02J 7/0031; H02J 7/0047; H02J 7/0063; H02J 7/00712; H02J 7/0013; H01M 10/482; H01M 50/583; B25F 5/008

(57) ABSTRACT

A battery pack includes a battery, a coupling portion, a connection determiner, a receiver, and a prohibition range controller. The prohibition range controller varies a prohibition range depending on the connection or non-connection of the electric work machine that is determined by the connection determiner, or the specification of the electric work machine connected to the coupling portion. The prohibition range is defined by a current range and a voltage range. A discharge from the battery is prohibited in the prohibition range.

### CROSS-REFERENCE TO RELATED APPLICATION

The present international application claims the benefit of Japanese patent application No. 2020-210606 filed with the Japan Patent Office on Dec. 18, 2020 and the entire disclosure of which is incorporated herein by reference.

### TECHNICAL FIELD

The present disclosure relates to a battery pack that supplies electric power to an electric work machine.

### BACKGROUND ART

A battery pack disclosed in Patent Document 1 prohibits a discharge from a battery when overload or over-discharge of the battery is detected.

### PRIOR ART DOCUMENTS

### Patent Documents

Patent Document 1. Japanese Patent No. 6173925

### SUMMARY OF THE INVENTION

### Problems to be Solved by the Invention

In the aforementioned battery pack, a condition for prohibiting the discharge is fixed. Accordingly, regardless of a power supply target of the battery, the discharge is stopped under the same condition. However, even if the battery is further discharged to some power supply targets, the battery may be protected. Accordingly, it is desired to improve practical utility of the battery pack.

One aspect of the present disclosure is to provide a battery pack with a greater practical utility.

### Means for Solving the Problems

A battery pack according to one aspect of the present disclosure includes a battery, a coupling portion, a connection determiner, a receiver, and a prohibition range controller. The coupling portion is configured to be connected to an electric work machine. The connection determiner is configured to determine connection or non-connection of the electric work machine to the coupling portion. The receiver is configured to receive work machine information from the electric work machine connected to the coupling portion. The work machine information includes a specification of the electric work machine. The prohibition range controller is configured to vary a prohibition range depending on (i) the connection or non-connection of the electric work machine that is determined by the connection determiner, or (ii) the specification of the electric work machine connected to the coupling portion. The prohibition range is defined by a current range and a voltage range. A discharge from the battery is prohibited in the prohibition range. The current range is a range of a discharge current value. The voltage range is a range of a discharge voltage value.

The battery pack according to one aspect of the present disclosure varies the prohibition range depending on (i) the determined connection or non-connection of the electric work machine, or (ii) the specification of the electric work machine connected. Accordingly, a prohibition range when the battery pack is connected to the examination device, not to the electric work machine, to execute an examination, can be changed to a prohibition range when the battery pack is connected to the electric work machine. Also, a prohibition range when an electric work machine with a relatively low necessity of protecting the battery pack is connected to the battery pack can be changed to a prohibition range when an electric work machine with a relatively high necessity of protecting the battery pack is connected. Further, a prohibition range when an electric work machine incapable to stop its operation instantly is connected to the battery pack can be changed to a prohibition range when an electric work machine capable to stop its operation instantly is connected. This enables practical utility of battery pack to be improved.

The specification of the electric work machine may include a load of the electric work machine.

In a case where the battery pack is connected to an electric work machine with a relatively small load, the necessity of protecting the battery pack is distinct from in a case where the battery pack is connected to an electric work machine with a relatively large load. Accordingly, varying the prohibition range depending on the load of the electric work machine allows practical utility of the battery pack to be improved.

The specification of the electric work machine may include whether the electric work machine includes an actuator that performs a series of movements. The series of movements may correspond to a movement in which the actuator moves from a first position to a second position and returns from the second position to the first position.

If the discharge stops during the series of movements by the actuator that performs a series of movements, an operation of the electric work machine ends midway through the operation, and thereby an operation efficiency decreases. Accordingly, varying the prohibition range depending on whether the electric work machine includes the series of movements allows practical utility of battery pack to be improved.

The first position may correspond to an initial position of the actuator. The second position may correspond to a position at which the actuator has a maximum amount of displacement from the initial position.

It is possible to inhibit a decrease in the operation efficiency of the electric work machine including the actuator, the actuator moving to a maximally displaced position from the initial position, and returns to the initial position from the maximally displaced position.

The specification of the electric work machine may include whether the electric work machine includes a cooling fan and/or a light.

There may be desires, such as cooling inside an electric work machine and illuminating a light after the discharge from a battery to a main motor stops and the operation stops. In such cases, it is desired to drive a cooling fan, and illuminate a light. Accordingly, varying the prohibition range depending on whether the electric work machine includes the cooling fan and/or the light allows practical utility of battery pack to be improved.

The battery may include a first battery block and a second battery block. The first battery block may be connected in series or in parallel to the second battery block in accordance with the electric work machine connected to the coupling portion. The specification of the electric work machine may include whether the first battery block and the second battery block are connected in series or in parallel.

In a case where the first battery block and the second battery block are connected in parallel, a current value flowing through each of two or more cells is smaller, compared to in a case where the first battery block and the second battery block are connected in series. Accordingly, in the case of the connection in parallel, the necessity of protecting the battery pack is distinct from in the case of the connection in series. Accordingly, varying the prohibition range depending on the connection in parallel or series allows practical utility of battery pack to be improved.

The prohibition range controller may set the prohibition range to be narrower in a case where the connection determiner determines the non-connection of the electric work machine, than in a case where the connection determiner determines the connection of the electric work machine.

In a case where the examination device, instead of the electric work machine, is connected to the coupling portion to execute an examination, the prohibition range is set to be narrower than in a case where the electric work machine is connected to the coupling portion. Accordingly, it is possible to inhibit the discharge from immediately stopping during the examination, thereby avoid failing to continue the examination of the battery pack.

The prohibition range controller may set the prohibition range to be narrower in a case where the load is small, than in a case where the load is large.

In a case of the electric work machine with a relatively small load, the necessity of protecting the battery pack is lower than in a case of the electric work machine with a relatively large load. Accordingly, it is possible to set the prohibition range to be narrower in the case of the electric work machine with the relatively small load, than in the case of the electric work machine with the relatively large load, thereby using the battery pack more effectively.

The prohibition range controller may set the prohibition range to be narrower in a case where the electric work machine includes the actuator that performs the series of movements, than in a case where the electric work machine does not include the actuator that performs the series of movements.

If the electric work machine includes the actuator that performs the series of movements, the prohibition range can be set to be relatively narrow, so that it is possible to inhibit the actuator from stopping during the series of movements, thus inhibiting an operation efficiency from decreasing.

The prohibition range controller may set the prohibition range to be narrower in a case where the electric work machine includes the cooling fan and/or the light, than in a case where the electric work machine does not include the cooling fan and/or the light.

If the electric work machine includes the cooling fan and/or the light, the prohibition range is set to be relatively small. Accordingly, even after a relatively large supply of electric power to the main motor of the electric work machine stops, it is possible to supply a relatively small amount of electric power to the cooling fan and/or the light. Thus, even after an operation of the electric work machine stops, the cooling fan and/or the light can be used.

The prohibition range controller may set the prohibition range to be narrower in the case of the connection in parallel, than in the case of the connection in series

In the case where the first battery block and the second battery block are connected in parallel, a current value flowing through each of the two or more cells is smaller than in the case where the first battery block and the second battery block are connected in series. Accordingly, in the case of the connection in parallel, the necessity of protecting the battery pack is lower than in the case of the connection in series. Accordingly, it is possible to set the prohibition range to be narrower in the case of the connection in parallel, than in the case of the connection in series. This enables the battery pack to be used more effectively.

The prohibition range may include a first range and a second range. The discharge current value in the current range of the second range may be smaller than that in the current range of the first range. The current range of the second range is adjacent to the current range of the first range. The prohibition range controller may fix the first range, and set the voltage range of the second range to be narrow, thereby to set the prohibition range to be narrow.

It is possible to expand the voltage range where the battery pack is usable, thereby to use the battery pack effectively while protecting the battery pack appropriately.

The prohibition range may include a first range and a second range. The discharge current value in the current range of the second range may be smaller than that in the current range of the first range. The current range of the second range is adjacent to the current range of the first range. The prohibition range controller may fix the first range, and set the current range of the second range to be narrow, thereby to set the prohibition range to be narrow.

It is possible to expand the current range where the battery pack is usable, thereby to use the battery pack effectively while protecting the battery pack appropriately.

In another aspect of the present disclosure, a battery pack according to Items 1 through 11 described below may be provided.

Item 1.

A battery pack, includes:
a battery;
a coupling portion configured to be connected to an electric work machine;
a connection determiner configured to determine connection or non-connection of the electric work machine to the coupling portion;
a receiver configured to receive work machine information from the electric work machine connected to the coupling portion, the work machine information including a specification of the electric work machine;
a current detector configured to detect a discharge current value flowing from the battery;
a memory device that stores two or more pieces of correlation data indicating a correspondence between the discharge current value and a counter addition/subtraction value, the two or more pieces of correlation data being distinct from each other depending on (i) the connection or non-connection of the electric work machine or (ii) the specification of the electric work machine connected to the coupling portion;
an addition/subtraction value calculator configured to calculate a counter addition/subtraction value in a preset cycle, based on the selected correlation data and on the discharge current value detected by the current detector, the selected correlation data being selected from the two or more pieces of correlation data depending on (i) the connection or non-connection of the electric work machine that is determined by the connection determiner or (ii) the specification of the electric work machine connected to the coupling portion;
a counter value calculator configured to integrate the counter addition/subtraction value calculated by the addition/subtraction value calculator, thereby to calculate a counter value; and
a discharge controller configured to prohibit a discharge from the battery in response to the counter value reaching a threshold, the counter value being calculated by the counter calculator.

The battery pack in another aspect of the present disclosure calculates the counter addition/subtraction value, based on the detected discharge current value and on the selected correlation data selected depending on (i) the determined connection or non-connection of the electric work machine or (ii) the specification of the electric work machine connected. The battery pack integrates the calculated counter addition/subtraction value to calculate the counter value, and determinates an over-current state in response to the counter value reaching a threshold, thereby to prohibit a discharge from the battery. Accordingly, it is possible to vary a time period from a discharge start to a discharge stop depending on (i) the determined connection or non-connection of the electric work machine, or (ii) the specification of the electric work machine connected. Accordingly, practical utility of the battery pack can be improved.

Item 2.

The battery pack according to Item 1, wherein the specification of the electric work machine includes a load of the electric work machine.

In a case where an electric work machine with a relatively small load is connected to the battery pack, the necessity of protecting the battery pack is distinct from in a case where an electric work machine with a relatively large load is connected to the battery pack. Accordingly, varying the selected correlation data depending on the load of the electric work machine allows practical utility of battery pack to be improved.

Item 3.

The battery pack according to Item 1 or 2, wherein the electric work machine includes whether the electric work machine includes an actuator that performs a series of movements, the series of movements corresponding to a movement in which the actuator moves from a first position to a second position and returns from the second position to the first position.

If the discharge stops during the series of movements by the actuator that performs the series of movements, an operation of the electric work machine ends midway through the operation, and thereby the operation efficiency decreases. Accordingly, varying the selected correlation data depending on whether the electric work machine includes the actuator that performs the series of movements allows practical utility of battery pack to be improved.

Item 4.

The battery pack according to Item 3,
wherein the first position corresponds to an initial position of the actuator, and
wherein the second position corresponds to a position at which the actuator has a maximum amount of displacement from the initial position.

It is possible to inhibit a decrease in an operation efficiency of an electric work machine with the actuator, the actuator moving to a maximally displaced position from the initial position, and returns to the initial position from the maximally displaced position.

Item 5.

The battery pack according to any one of Items 1 through 4, wherein the specification of the electric work machine includes whether the electric work machine includes a cooling fan and/or a light.

There may be desires, such as cooling inside of an electric work machine and illuminating a light after a discharge from a battery to a main motor stops and the operation stops. In such cases, it is desired to drive a cooling fan, and illuminate a light. Accordingly, varying the selected correlation data depending on whether the electric work machine includes the cooling fan and/or the light allows practical utility of battery pack to be improved.

Item 6.

The battery pack according to any one of Items 1 through 5, wherein the battery includes a first battery block and a second battery block, the first battery block being configured to be connected in series or in parallel to the second battery block in accordance with the electric work machine connected to the coupling portion, and
wherein the specification of the electric work machine includes whether the first battery block and the second battery block are connected in series or in parallel.

In a case where the first battery block and the second battery block are connected in parallel, a current value flowing through each of two or more cells is smaller, compared to in a case where the first battery block and the second battery block are connected in series. Accordingly, in the case of the connection in parallel, the necessity of protecting the battery pack is distinct from in the case of the connection in series. Accordingly, varying the selected correlation data depending on the connection in parallel or series allows practical utility of battery pack to be improved.

Item 7.

The battery pack according to any one of Items 1 through 6, wherein the counter addition/subtraction value includes: a counter addition value that is a positive value; and a counter subtraction value that is a negative value, the counter addition value corresponding to a discharge current value equal to or greater than a preset value, the counter subtraction value corresponding to a discharge current value less than the preset value, and
wherein the counter addition value of first correlation data is set to be greater than the counter addition value of second correlation data, the first correlation data corresponding to correlation data, of the two or more pieces of correlation data, in accordance with the non-connection of the electric work machine, the second correlation data corresponding to correlation data, of the two or more pieces of correlation data, in accordance with the connection of the electric work machine.

In the case where the non-connection of the electric work machine is determined, a rate of increase of the counter value becomes greater and thereby the discharge stops promptly, compared to in the case where the connection of the electric work machine is determined. Accordingly, in the case where the coupling portion is not connected to the electric work machine but is discharging, it is possible to stop the discharge promptly, thereby to protect the battery pack. Further, in a case where an electric work machine other than the electric work machine that is under a regular control is connected to the coupling portion, the connection of the electric work machine is not determined and the non-connection of the electric work machine is determined. Thus, even if any electric work machine is connected to the coupling portion, unless the discharge under the regular control is performed, it is possible to stop the discharge promptly, thereby to protect the battery pack.

Item 8.

The battery pack according to any one of Items 1 through 7, wherein a magnitude of the counter subtraction value of the first correlation data is set to be smaller than a magnitude of the counter subtraction value of the second correlation data.

In the case where non-connection of the electric work machine is determined, a rate of decrease of the counter value becomes smaller, compared to the case where the connection of the electric work machine is determined. Accordingly, in a case of an anomalous discharge of the battery pack 6, protection for a battery pack is more increased, compared to a case of a normal discharge of the battery pack 6.

Item 9.

The battery pack according to Item 7 or 8,

wherein the specification of the electric work machine includes a load of the electric work machine, and
wherein the counter addition value of third correlation data is set to be greater than the counter addition value of fourth correlation data, the third correlation data corresponding to correlation data, of the two or more pieces of correlation data, in accordance with the load being large, the fourth correlation data corresponding to correlation data, of the two or more pieces of correlation data, in accordance with the load being small.

In a case where the load of the electric work machine connected to the battery pack is high, the rate of increase of the counter value becomes greater, compared to in the case where the load is small, so that it is possible to stop the discharge promptly, thereby to protect the battery pack.

Item 10.

The battery pack according to Item 9, wherein a magnitude of the counter subtraction value of the third correlation data is set to be smaller than a magnitude of the counter subtraction value of the fourth correlation data

In a case where the load of the electric work machine connected to the battery pack is high, the rate of decrease of the counter value becomes smaller, compared to in the case where the load is small, so that it is possible to increase protection of the battery pack.

Item 11.

The battery pack according to Item 9 or 11, wherein the counter addition value of the first correlation data is set to be greater than the counter addition value of the third correlation data.

In the case where the non-connection of the electric work machine is determined, compared to in the case where the load of the electric work machine connected is high, the rate of increase of the counter value becomes greater, and thereby the discharge is stopped promptly. Accordingly, in the case of the anomalous discharge of the battery pack, it is possible to increase protection of the battery pack, compared to in the case where the load of the electric work machine connected to the battery pack is high.

### BRIEF DESCRIPTION OF THE DRAWINGS

FIG. 1 is an external view of a pin tacker as an example of an electric work machine according to a first embodiment.

FIG. 2 is an external view of an impact driver as another example of the electric work machine according to the first embodiment.

FIG. 3 is a block diagram showing an electrical configuration of a battery system according to the first embodiment.

FIG. 4 is a view of an example of a discharge prohibition range and a usable range, according to the first embodiment.

FIG. 5 is a view of another example of the discharge prohibition range and the usable range, according to the first embodiment.

FIG. 6 is a flowchart showing a battery pack protection process according to the first embodiment.

FIG. 7 is a subroutine showing an interruption determination process according to the first embodiment.

FIG. 8A is a portion of a subroutine showing an interruption determination process according to a second embodiment.

FIG. 8B is the rest of the subroutine showing the interruption determination process according to the second embodiment.

FIG. 9 is a diagram showing an example of a classification of an electric work machine according to the second embodiment.

FIG. 10 is a diagram of an example in which a battery according to the second embodiment is used for the electric work machine, wherein the battery includes a first battery block and a second battery block, the first battery block being connected in series to the second battery block.

FIG. 11 is a diagram of an example in which the battery according to the second embodiment is used for the electric work machine, wherein the battery includes a first battery block and a second battery block, the first battery block being connected in parallel to the second battery block.

FIG. 12 is a flowchart showing a battery pack protection process according to a third embodiment.

FIG. 13 is a subroutine showing an over-current determination process according to the third embodiment.

FIG. 14 is one example of a graph showing a correlation between a discharge current value and a counter addition/subtraction value, according to the third embodiment.

FIG. 15 is one example of a graph showing a correlation between the discharge current value, and a reaching time when a discharge stop or an interruption determination is reached, according to the third embodiment.

FIG. 16 is a subroutine showing an over-current determination process according to a fourth embodiment.

FIG. 17 is one example of a graph showing a correlation between a discharge current value and a counter addition/subtraction value, according to the fourth embodiment.

FIG. 18 is one example of a graph showing a correlation between the discharge current value, and a reaching time when a discharge stop or an interruption determination is reached, according to the fourth embodiment.

### EXPLANATION OF REFERENCE NUMERALS

1 . . . battery system, 6 . . . battery pack, 150 . . . battery MCU, 10 . . . electric work machine, 10A . . . pin tacker, 10B . . . impact driver, 12 . . . motor housing, 18, 22 . . . trigger, 23 . . . tip tool, 100 . . . battery-side coupling portion, 111 . . . first positive terminal, 112 . . . first negative terminal, 113 . . . charging terminal, 114 . . . first discharge terminal, 115 . . . first detection terminal, 116 . . . first communication terminal, 130A . . . first battery block, 130B . . . second battery block, 135 . . . temperature detection circuit, 162 . . . interruption device, 163 . . . battery shunt resistor, 171 . . . charging control circuit, 172 . . . first discharging control circuit, 173 . . . first detection circuit, 174 . . . first communication circuit, 180 . . . first positive electrode line, 190 . . . first negative electrode line, 200A, 200B . . . working-machine-side coupling portion, 211 . . . second positive terminal, 212 . . . second negative terminal, 214 . . . second discharge terminal, 215 . . . second detection terminal, 216 . . . second communication terminal, work machine MCU . . . 250, 260 . . . driver, 270 . . . motor, 272 . . . second discharging control circuit, 273 . . . second detection circuit, 274 . . . second communication circuit, 280 . . . light, 281 . . . cooling fan, 282 . . . FET, 283 . . . work machine shunt resistor, 284 . . . switch, 290 . . . hammer driving mechanism, 480 . . . second positive electrode line, 490 . . . second negative electrode line.

### MODE FOR CARRYING OUT THE INVENTION

Hereinafter, embodiments for carrying out the present invention will be described with reference to the drawings.

### First Embodiment

### 1. Configuration

<1-1. Overall Configuration of Battery System>

A battery system 1 of the present embodiment includes a battery pack 6 and an electric work machine 10. The battery pack 6 is connected to the electric work machine 10 and supplies electric power to the electric work machine 10. The electric work machine 10 receives the electric power from the battery pack 6 to be driven.

The battery pack 6 includes a rechargeable battery 130 described below. The battery 130 includes two or more battery blocks, each of which includes two or more battery cells connected in series. The battery 130 is a lithium-ion battery.

A battery-side coupling portion 100 provided on an upper surface of the battery pack 6 is connected to the electric work machine 10. The battery-side coupling portion 100 includes two or more terminals described below.

The electric work machine 10 includes an electric power tool, a gardening tool, and so forth. The electric power tool includes a pin tacker, an impact driver, and so forth. The gardening tool includes a grass mower, a trimmer, and so forth.

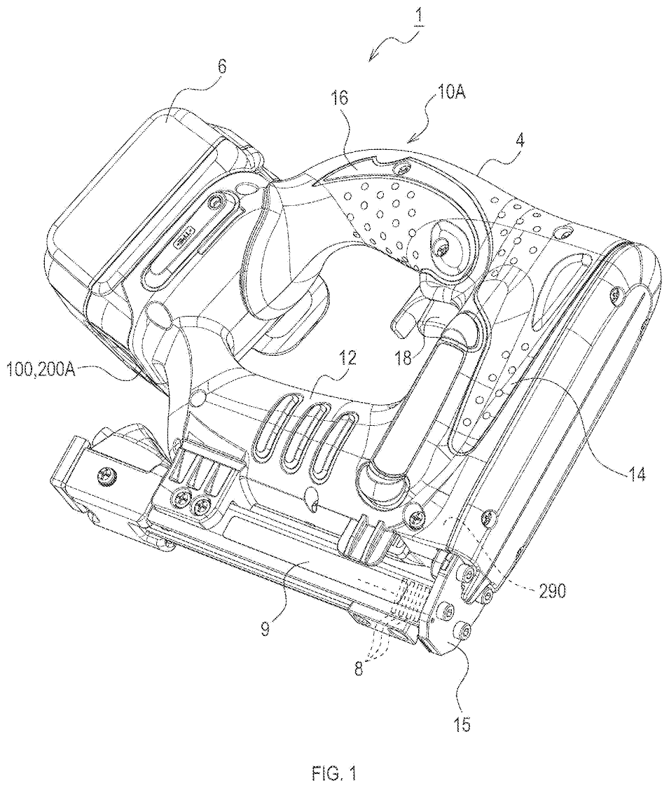

First, as one example of the electric work machine 10, a pin tacker 10A is described with reference to FIG. 1. The pin tacker 10A includes a main body 4 and a magazine 9. The main body 4 includes a working-machine-side coupling portion 200A, a motor housing 12, a handle grip 16, a trigger 18, a gear-housing 14, and an emitter 15. In another embodiment, the main body 4 or the magazine 9 may be removed from the pin tacker 10A. In another embodiment, at least one of the working-machine-side coupling portion 200A, the motor housing 12, the handle grip 16, the trigger 18, the gear-housing 14, and the emitter 15 may be removed from the main body 4.

The motor housing 12 houses a motor 270 and a driver 260, which are described below. The handle grip 16 is provided above the motor housing 12, and is gripped by a user. The working-machine-side coupling portion 200A is provided at first ends of the motor housing 12 and the handle grip 16 in a horizontal direction of the motor housing 12 and the handle grip 16, and is configured to be connected to the battery-side coupling portion 100. The working-machine-side coupling portion 200A includes two or more terminals described below.

The trigger 18 is provided on the handle grip 16. The user pulls the trigger 18, and thereby a control command for driving the motor 270 is input to the driver 260, so that the motor 270 is driven by the driver 260.

The gear-housing 14 is provided at a second end of the motor housing 12 and the handle grip 16 in the horizontal direction, and houses a hammer driving mechanism 290 that is not shown. The second end is opposite to the first end in the horizontal direction.

Two or more pins 8 are aligned in a line in the magazine 9, and housed in a state in which the pins 8 are biased by a spring from the first end (that is, a battery pack 6 side) toward the second end (that is, a gear-housing 14 side) along the line.

The hammer driving mechanism 290 moves a hammer within the gear-housing 14 from down (a first position) to up (a second position) due to rotation in the motor 270 to compress a compression coil spring, and thereafter drives the hammer downward (to the first position) with a resilient force of the compression coil spring, thereby to emit the pins 8 from the emitter 15. That is, the motor 270 and the hammer driving mechanism 290 performs a series of movements in which the hammer is moved from the first position to the second position and returned from the second position to the first position. The first position corresponds to an initial position of the motor 270 and the hammer driving mechanism 290, and the second position corresponds to a position where displacement amount from the initial position of the motor 270 and the hammer driving mechanism 290 is maximum. In the present embodiment, the motor 270 and the hammer driving mechanism 290 correspond to one example of an actuator of the present disclosure.

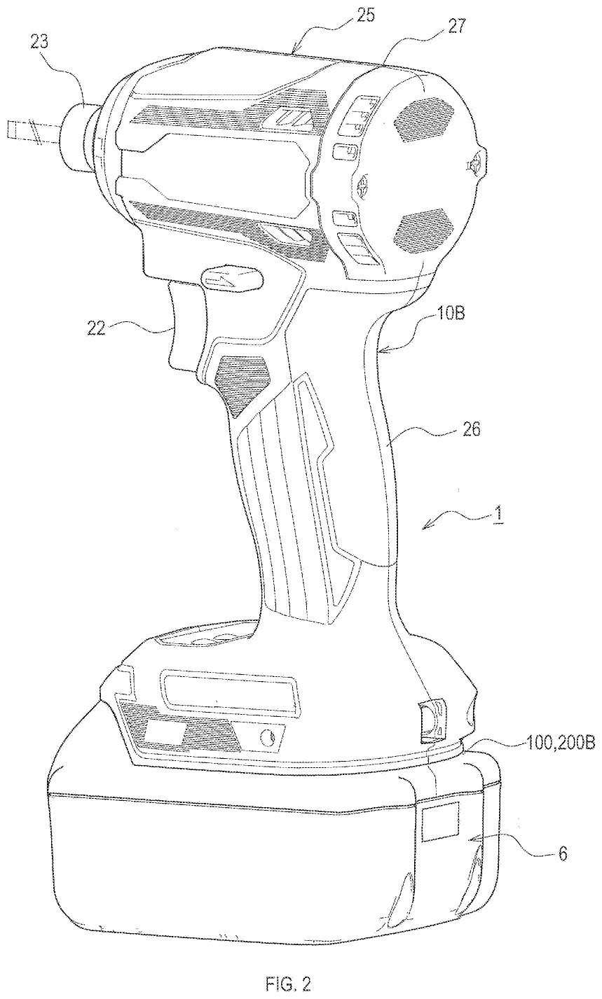

Next, as one example of the electric work machine 10, an impact driver 10B is described with reference to FIG. 2. The impact driver 10B includes a pillar-like grip 26, a column-like head 27, a trigger 22, and a working-machine-side coupling portion 200B. In another embodiment, at least one of the grip 26, the head 27, the trigger 22, and the working-machine-side coupling portion 200B may be removed from the impact driver 10B.

The grip 26 is gripped by the user. The head 27 is disposed above the grip 26, and houses the motor 270 and the driver 260 described below. Further, the head 27 is configured to have a distal end to be attachable to a tip tool 23.

The working-machine-side coupling portion 200B is provided on a lower surface of the grip 26, and configured to be connected to the battery-side coupling portion 100. The working-machine-side coupling portion 200B includes two or more terminals described below. That is, the working-machine-side coupling portion 200B is configured to have a similar shape to that of the working-machine-side coupling portion 200A. Hereinafter, the working-machine-side coupling portion 200A and the working-machine-side coupling portion 200B are collectively referred to as a working-machine-side coupling portion 200.

The trigger 22 is provided on the grip 26. The user pulls the trigger 22, and thereby the control command for driving the motor 270 is input to the driver 260, so that the motor 270 is driven by the driver 260. Thus, the user pulls the trigger 22, and thereby the tip tool 23 is rotated.

<1-2. Electrical Configuration of Battery System>

<1-2-1. Electrical Configuration of Battery Pack>

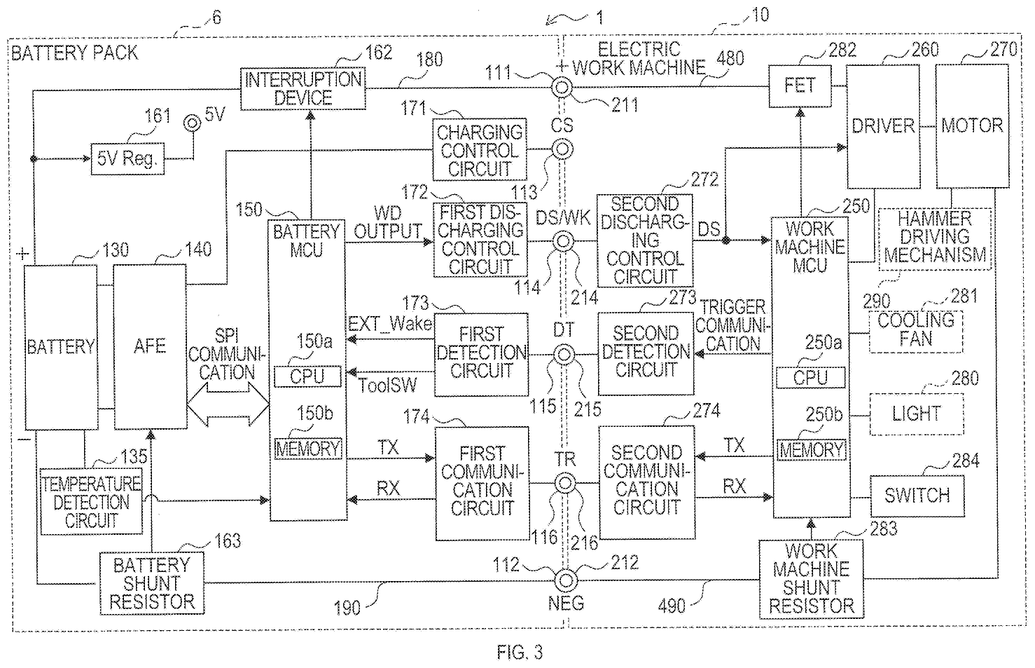

Next, an electrical configuration of the battery pack 6 is described with reference to FIG. 3. The battery pack 6 includes a battery 30, a battery Micro Control Unit (hereinafter, MCU) 150, an Analog Front End (hereinafter, AFE) 140, a regulator 161, an interruption device 162, a battery shunt resistor 163, a temperature detection circuit 135, a charging control circuit 171, a first discharging control circuit 172, a first detection circuit 173, and a first communication circuit 174. In another embodiment, at least one of the MCU 150, the AFE 140, the regulator 161, the interruption device 162, the battery shunt resistor 163, the temperature detection circuit 135, the charging control circuit 171, the first discharging control circuit 172, the first detection circuit 173, and the first communication circuit 174 may be removed from the battery pack 6.

The battery-side coupling portion 100 includes six terminals. Specifically, the battery-side coupling portion 100 includes a first positive terminal 111, a first negative terminal 112, a charging terminal 113, a first discharge terminal 114, a first detection terminal 115, and a first communication terminal 116. In another embodiment, at least one of the first positive terminal 111, the first negative terminal 112, the charging terminal 113, the first discharge terminal 114, the first detection terminal 115, and the first communication terminal 116 may be removed from the battery-side coupling portion 100.

The first positive terminal 111 is connected to a positive electrode of the battery 130 through a first positive electrode line 180. The first negative terminal 112 is connected to a negative electrode of the battery 130 through a first negative electrode line 190. The charging terminal 113 is connected to the charging control circuit 171. The first discharge terminal 114 is connected to the first discharging control circuit 172. The first detection terminal 115 is connected to the first detection circuit 173. The first communication terminal 116 is connected to the first communication circuit 174.

The regulator 161 is connected to the positive electrode of the battery 130, and receives electric power from the battery 130. The regulator 161 generates a power source to supply to various circuits within the battery pack 6, such as the battery MCU 150 and the AFE 140.

The battery shunt resistor 163 is provided in the first negative electrode line 190, and detects a value of charge current flowing into the battery 130 and a value of discharge current flowing from the battery 130, and outputs the detected current value to the AFE 140. The temperature detection circuit 135 detects a battery temperature of the battery 130, and outputs the detected battery temperature to the battery MCU 150.

The AFE 140 is an analog circuit, and is configured to execute Serial Peripheral Interface (SPI) communication with the battery MCU 150. In accordance with a command from the battery MCU 150, the AFE 140 detects a cell voltage value of each battery cells included in the battery 30 and a battery voltage value of the battery 130. Also, the AFE 140 executes a cell balance process to equalize the remaining capacities of the two or more battery cells. Furthermore, the AFE 140 converts the detected cell voltage value and battery voltage value, an input current value, and the like into digital signals and sends each converted digital signal to the battery MCU 150.

Further, if the battery pack 6 is connected to a charger, the AFE 140 determines a state of the battery 130 based on each of various input values. In the cases where charging of the battery 30 should be stopped (for example, in the case of an overcharging state), the AFE 140 sends a charging stop signal to the charging control circuit 171. When the charging stop signal is input from the AFE 40, the charging control circuit 171 outputs a discharging stop signal from the charging terminal 113 to the charger.

The battery MCU 150 includes a microcomputer having a CPU 150a, a memory 150b, an I/O unit, and others. The battery MCU 150 is connected to the discharging control circuit 172, the first detection circuit 173, and the first communication circuit 174.

The first detection circuit 173 detects the connection or non-connection of the electric work machine 10 or the charger to the battery pack 6, based on an electrical potential of the first detection terminal 115, and outputs a connection signal or a non-connection signal to the battery MCU 150.

The first communication circuit 174 is a Universal Asynchronous Receiver/Transmitter (UART) executing a half-duplex serial communication. The first communication circuit 174 transmits and receives data through the first communication terminal 116.

In response to the connection signal being input from the first detection circuit 173, the battery MCU 150 shifts from an energy saving mode to an active mode. If the battery pack 6 is connected to the electric work machine 10, the battery MCU 150 executes the discharging control of the battery 130. If the battery pack 6 is connected to the charger, the battery MCU 150 executes the charging control of the battery 130.

Specifically, the battery MCU 150 executes the discharging control and charging control of the battery 30 based on the cell voltage, the battery voltage value, and the discharge current value that are received from the AFE 140, and on the battery temperature that is input from the first temperature detection circuit 135.

If the battery 130 is in any of an over-current state, an over-heated state, and an over-discharge state, the battery MCU 150 outputs, to the first discharging control circuit 172, a discharge prohibition signal that prohibits the discharge from the battery 30. Further, if the battery 130 is in a dischargeable state, the battery MCU 150 outputs a discharge permission signal to the first discharging control circuit 172. The first discharging control circuit 172 outputs, from the first discharge terminal 114 to the electric work machine 10, the discharge prohibition signal or discharge permission signal inputted from the battery MCU 150. Further, if determining the battery 30 is in the dischargeable state, the battery MCU 150 outputs a watchdog pulse signal (a pulse signal at constant intervals) to the first discharging control circuit 172. If the watchdog pulse signal is not input, the first discharging control circuit 172 outputs the discharge prohibition signal from the first discharge terminal 114 to the electric work machine 10. In response to receiving the discharge prohibition signal, the electric work machine 10 interrupts a discharge path from the battery 130 to the motor 270.

In addition, if the battery MCU 150 outputs the discharge prohibition signal to the electric work machine 10 but the discharge is continued and the cell voltage value and discharge current value of the battery 130 enter a prohibition range AA, the battery MCU 150 turns off the interruption device 162 and interrupts establishment of the first positive electrode line 180. For example, if the interruption device 162 is a Field Effect Transistor (FET), the battery MCU 150 turns off the FET. If the interruption device 162 is SCP, the battery MCU 150 blows a fuse of the SCP.

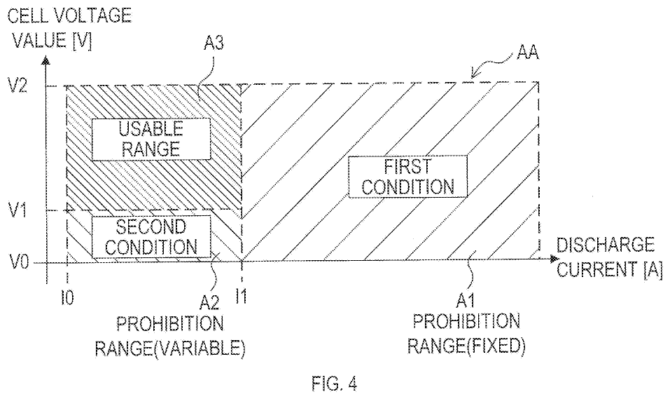

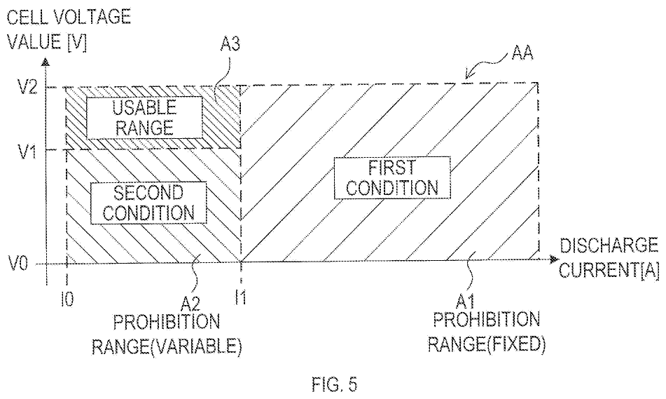

As shown in FIG. 4 and FIG. 5, the prohibition range AA is defined by a current range and a voltage range. The current range corresponds to a range of the discharge current value greater than I0. The voltage range corresponds to a range of the cell voltage value less than V2.

Herein, there are cases in which the battery pack 6 can be protected even if the prohibition range AA is relatively narrowed, for example, a case where the electric work machine 10 is a type of machine with a relatively small load. Accordingly, the battery MCU 50 does not fix the prohibition range AA and varies the prohibition range AA depending on whether the electric work machine 10 is connected, and/or a specification of the electric work machine 10.

The prohibition range AA includes a first range A1 and a second range A2. The first range A1 has a range of a discharge current value greater than 11 and a range of a cell voltage value less than V2. The second range A2 has a range of a discharge current value greater than I0 and less than or equal to I1, and a range of a cell voltage value equal to or greater than V0 and less than V1. That is, the current range of the second range A2 has a discharge current value smaller than that of the first range A1, and is adjacent to the current range of the first range A1. Herein, the cell voltage value is V2>V1>V0, for example, where V2=2.5V, V1=1.0V, and V0=0V. The discharge current value is I1>I0, for example, where I1=50 A and I0=5 A.

As shown in FIG. 4 and FIG. 5, the battery MCU 150 fixes the first range A1, and varies the ranges of the second range A2. Thus, the battery MCU 150 varies a usable range A3. The usable range A3 is a range excluding the second range A2 from a range defined by the current range greater than I0 and the voltage range less than V2.

<1-2-2. Electrical Configuration of Electric Work Machine>

Next, an electrical configuration of the electric work machine 10 is described with reference to FIG. 3. The electric work machine 10 includes a work machine MCU 250, the driver 260, the motor 270, an FET 282, a work machine shunt resistor 283, a second discharging control circuit 272, a second detection circuit 273, a second communication circuit 274, and a switch 284. In another embodiment, at least one of the work machine MCU 250, the driver 260, the motor 270, the FET 282, the work machine shunt resistor 283, the second discharging control circuit 272, the second detection circuit 273, the second communication circuit 274, and the switch 284 may be removed from the electric work machine 100.

The working-machine-side coupling portion 200 includes a second positive terminal 211, a second negative terminal 212, a second discharge terminal 214, a second detection terminal 215, and a second communication terminal 216. In another embodiment, at least one of the second positive terminal 211, the second negative terminal 212, the second discharge terminal 214, the second detection terminal 215, and the second communication terminal 216 may be removed from the working-machine-side coupling portion 200.

The second positive terminal 211 is configured to be connected to the first positive terminal 111. The second negative terminal 212 is configured to be connected to the first negative terminal 112. The second discharge terminal 214 is configured to be connected to the first discharge terminal 114. The second detection terminal 215 is configured to be connected to the first detection terminal 115. The second communication terminal 216 is configured to be connected to the first communication terminal 116.

The motor 270 is a three-phase brushless motor. The driver 260 is a three-phase bridge circuit for driving the motor 270. The driver 260 drives the motor 270 in response to the control command from the work machine MCU 250. In another embodiment, the motor 270 may be a brushed motor.

The FET 282 is provided in a second positive electrode line 480. The second positive electrode line 480 is a line that connects the second positive terminal 211 to the motor 270. The work machine shunt resistor 283 is provided in a second negative electrode line 490. The second negative electrode line 490 is a line that connects the second negative terminal 212 to the motor 270. The work machine shunt resistor 283 detects a current value flowing through the motor 270, and outputs the detected current value to the work machine MCU 250.

The work machine MCU 250 includes a microcomputer having a CPU 250a, a memory 250b, an I/O unit, and others. The work machine MCU 250 is connected to the switch 284, the second discharging control circuit 272, the second detection circuit 273, and the second communication circuit 274.

When the triggers 18, 22 of the electric work machine 10 are pulled, the switch 284 outputs an ON-signal to the work machine MCU 250. When the triggers 18, 22 are released, the switch 284 outputs an OFF-signal to the work machine MCU 250.

If the discharge prohibition signal is input through the second discharge terminal 214, the second discharging control circuit 272 outputs the discharge prohibition signal to the work machine MCU 250, and outputs a stop signal to the driver 260. The stop signal corresponds to a control command for stopping the driving of the motor 270. In response to the discharge prohibition signal being input, the work machine MCU 250 outputs the stop signal to the driver 260 and turns off the FET 282. If the work machine MCU 250 receives by serial communication through the second communication terminal 216 and the second communication circuit 274 that the battery 130 is in a discharge prohibition state, the work machine MCU 250 outputs the stop signal to the driver 260 and turns off the FET 282. Accordingly, in response to the discharge prohibition signal being output from the battery pack 6 to the electric work machine 10 or the discharge prohibition state being transmitted by serial communication, the driver 260 stops driving of the motor 270 and establishment of the second positive electrode line 480 is interrupted.

The second detection circuit 273 detects the connection or non-connection of the battery pack 6 to the electric work machine 10 based on an electric potential of the second detection terminal 215, and outputs a connection signal or non-connection signal to the work machine MCU 250.

The second communication circuit 274 is a Universal Asynchronous Receiver/Transmitter (UART) executing a half-duplex serial communication. The second communication circuit 274 transmits and receives data through the second communication terminal 216.

The electric work machine 10 may further include a cooling fan 281 and/or a light 280. The cooling fan 281 and the light 280 have a sufficiently smaller power consumption than the motor 270. The cooling fan 281 is provided to cool heat generated due to driving of the motor 270.

### 2. Process

<2-1. Battery Pack Protection Process>

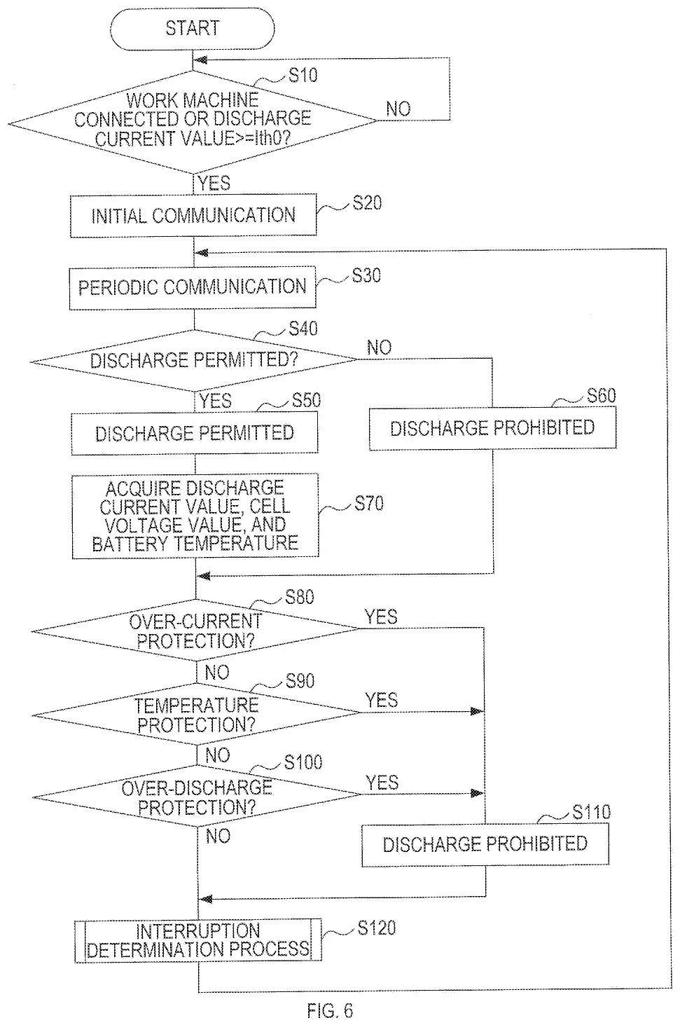

Next, a protection process for the battery pack 6 that is executed by the battery MCU 150 is described with reference to a flowchart of FIG. 6.

First, in S10, the battery MCU 150 determines, based on an input signal from the first detection circuit 173, whether the electric work machine 10 is connected to the battery pack 6, or whether the discharge current value is equal to or greater than an interruption threshold Ith0. The interruption threshold Ith0 is a smaller value than a value in the current range of the prohibition range AA, and corresponds to I0. If the discharge current value is less than the interruption threshold Ith0, discharging can be continued. If it is determined that the electric work machine 10 is not connected to the battery pack 6 and that the discharge current value is less than the interruption threshold Ith0, the battery MCU 150 repeatedly executes S10 until it is determined that the electric work machine 10 is connected to the battery pack 6 or the discharge current value is equal to or greater than the interruption threshold Ith0. If the battery MCU 150 determines that the electric work machine 10 is connected or that the discharge current value is equal to or greater than the interruption threshold Ith0, the battery MCU 150 proceeds to S20.

In S20, the battery MCU 150 performs initial communication with the electric work machine 10 by serial communication through the first communication circuit 174 and the first communication terminal 116. In the initial communication, the battery MCU 150 sends a model number of the battery pack 6 and so forth to the electric work machine 10, and receives work machine information from the electric work machine 10. The work machine information is the model number, a specification, and so forth of the electric work machine 10.

Subsequently, in S30, the battery MCU 150 performs periodic communication with the electric work machine 10 by serial communication through the first communication circuit 174 and the first communication terminal 116. The electric work machine 10 requests battery information from the battery pack 6, on a periodic basis. In response to the request being received from the electric work machine 10, the battery MCU 150 responds the battery information corresponding to the request.

Specifically, in S40, the battery MCU 150 determines whether an output signal that is output from the first discharge terminal 114 is the discharge permission signal or the discharge prohibition signal. If the output signal is the discharge permission signal, then in S50 the battery MCU 150 responds the discharge permission state to the electric work machine 10 by serial communication through the first communication circuit 174 and the first communication terminal 116. If the output signal is the discharge prohibition signal, then in S60 the battery MCU 150 responds the discharge prohibition state to the electric work machine 10 by serial communication through the first communication circuit 174 and the first communication terminal 116.

Subsequently, in S70, the battery MCU 150 acquires the discharge current value, the cell voltage value, and the battery temperature.

Subsequently, in S80, the battery MCU 150 determines whether to execute an over-current protection, based on the discharge current value acquired in S70. Specifically, if the discharge current value is equal to or greater than a current threshold, the battery MCU 150 determines to execute the over-current protection. If the battery MCU 150 determines not to execute the over-current protection, the battery MCU 150 proceeds to S90. If the battery MCU 150 determines to execute the over-current protection, the battery MCU 150 proceeds to S110.

Subsequently, in S90, the battery MCU 150 determines whether to execute a temperature protection, based on the battery temperature acquired in S70. Specifically, if the battery temperature is equal to or greater than a temperature threshold, the battery MCU 150 determines to execute the temperature protection. If the battery MCU 150 determines not to execute the temperature protection, the battery MCU 150 proceeds to S100. If the battery MCU 150 determines to execute the temperature protection, the battery MCU 150 proceeds to S110.

Subsequently, in S100, the battery MCU 150 determines whether to execute an over-discharge protection, based on the cell voltage value acquired in S70. Specifically, if the cell voltage value is equal to or less than a voltage threshold, the battery MCU 150 determines to execute the over-discharge protection. Herein, the voltage threshold is greater than a value in the voltage range of the prohibition range AA. If the battery MCU 150 determines not to execute the over-discharge protection, the battery MCU 150 proceeds to S120. If the battery MCU 150 determines to execute the over-discharge protection, the battery MCU 150 proceeds to S110.

In S110, the battery MCU 150 outputs, to the electric work machine 10, the discharge prohibition signal through the first discharging control circuit 172 and the first discharge terminal 114, and proceeds to S120.

In S120, the battery MCU 150 executes an interruption determination process, and returns to S30. The interruption determination process is described in details below.

<2-2. Interruption Determination Process>

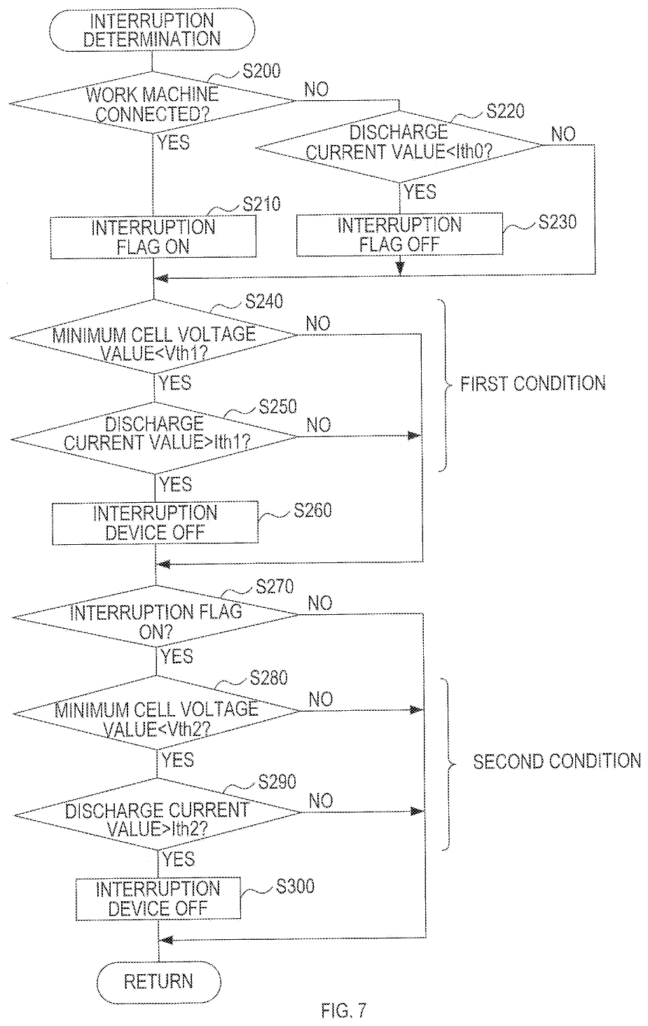

Next, the interruption determination process executed by the battery MCU 150 is described with reference to a subroutine in FIG. 7.

First, in S200, the battery MCU 150 determines whether the electric work machine 10 is connected to the battery pack 6, based on the input signal from the first detection circuit 173. In the present embodiment, the battery MCU 150 varies the range of the second range A2 depending on whether the electric work machine 10 is connected or not connected.

There are cases in which an examination device is connected to the battery pack 6 to execute an examination of the battery pack 6 during the electric work machine 10 being not connected to the battery pack 6. In the case where the examination of the battery pack 6 is executed, if the prohibition range AA is large, discharging may immediately stop during the examination, and thus the examination of the battery pack 6 may be unable to be continued. Accordingly, in a case where the electric work machine 10 is not connected to the battery pack 6, the battery MCU 150 sets the prohibition range AA to be narrower than in the case where the electric work machine 10 is connected to the battery pack 6. Specifically, the battery MCU 150 sets the voltage range of the second range A2 to be narrower, thereby to narrow the prohibition range AA.

That is, in FIG. 4 and FIG. 5, if the electric work machine 10 is not connected to the battery pack 6, the battery MCU 150 lets a value of the cell voltage value V1 be relatively small, thereby to make the second range A2 relatively narrow and to make the usable range A3 relatively large. On the other hand, if the electric work machine 10 is connected to the battery pack 6, the battery MCU 150 lets the cell voltage value V1 be relatively large, thereby to make the second range A2 relatively large and to make the usable range A3 relatively narrow. The cell voltage value V1 may be equal to V2, and the cell voltage value V1 may be equal to V0.

In S210, the battery MCU 150 sets an interruption flag to ON, and sets a second voltage threshold Vth2 and a second current threshold Ith2 in accordance with the second range A2 that is set to be relatively large. That is, the battery MCU 150 sets the cell voltage value V1 to the second voltage threshold Vth2, and sets the discharge current value I0 to the second current threshold Ith2. Thereafter, the battery MCU 150 proceeds to S240.

In S220, the battery MCU 150 determines whether the discharge current value is less than the interruption threshold Ith0. If the battery MCU 150 determines that the discharge current value is less than the interruption threshold Ith0, the battery MCU 150 proceeds to S230. In S230, the battery MCU 150 sets the interruption flag to OFF, and the battery MCU 150 proceeds to S240.

On the other hand, if it is determined in S220 that the discharge current value is equal to or greater than the interruption threshold Ith0, that is, if it is determined that the electric work machine 10 is not connected and the discharge current value is equal to or greater than the interruption threshold Ith0, the battery MCU 150 does not set the interruption flag.

Subsequently, in S240 and S250, the battery MCU 150 determines whether a first condition is satisfied. The first condition is satisfied with the cell voltage value and the discharge current value of the battery 130 being within the first range A1.

First, in S240, the battery MCU 150 determines whether a minimum value of the acquired cell voltage values is less than a first voltage threshold Vth1. The first voltage threshold Vth1 is a fixed value that is set in accordance with the first range A1, and corresponds to the cell voltage value V2. If the battery MCU 150 determines that a minimum cell voltage value is equal to or greater than the first voltage threshold Vth1, the battery MCU 150 proceeds to S270. If the battery MCU 150 determines that the minimum cell voltage value is less than the first voltage threshold Vth1, the battery MCU 150 proceeds to S250.

In S250, the battery MCU 150 determines whether the discharge current value is greater than a first current threshold Ith1. The first current threshold Ith1 is a fixed value set in accordance with the first range A1, and corresponds to a discharge current value I1. If the battery MCU 150 determines that the discharge current value is equal to or less than the first current threshold Ith1, the battery MCU 150 proceeds to S270. If it is determined that the discharge current value is greater than the first current threshold Ith1, the battery MCU 150 proceeds to S260.

In S260, since the cell voltage value and the discharge current value of the battery 130 is within the first range A1, the battery MCU 150 turns off the interruption device 162, thus interrupting the establishment of the first positive electrode line 180. This causes the discharge from the battery 130 to stop.

Subsequently, in S270, the battery MCU 150 determines whether the interruption flag is ON. If the interruption flag is ON, the battery MCU 150 proceeds to S280. If the interruption flag is OFF, the battery MCU 150 completes this subroutine, and returns to S30.

Subsequently, in S280 and S290, the battery MCU 150 determines whether a second condition is satisfied, in response to the first condition not being satisfied. The second condition is satisfied with the cell voltage value and the discharge current value of the battery 130 being within the second range A2.

In S280, the battery MCU 150 determines whether the minimum cell voltage value is less than the second the voltage threshold Vth2. If the battery MCU 150 determines that the minimum cell voltage value is less than the second voltage threshold Vth2, the battery MCU 150 proceeds to S280. If the battery MCU 150 determines that the minimum cell voltage value is equal to or greater than the second voltage threshold Vth2, the battery MCU 150 completes this subroutine and returns to S30.

In S290, the battery MCU 150 determines whether the discharge current value is greater than the second current threshold Ith2. If the battery MCU 150 determines that the discharge current value is greater than the second current threshold Ith2, the battery MCU 150 proceeds to S300. If the battery MCU 150 determines that the discharge current value is equal to or less than the second current threshold Ith2, the battery MCU 150 completes this subroutine and returns to S30.

In S300, since the cell voltage value and the discharge current value of the battery 130 are within the second range A2, the battery MCU 150 turns off the interruption device 162, thus interrupting the establishment of the first positive electrode line 180. Thereafter, the battery MCU 150 completes this subroutine and returns to S30.

### 3. Effect

According to the first embodiment as described above, the following effects can be obtained.
(1-1) The battery pack 6 in the case where the electric work machine 10 is not connected sets the prohibition range AA to be narrower than in the case where the electric work machine 10 is connected. Accordingly, in the case where the examination device is connected to the battery pack 6 to execute the examination, the prohibition range AA is set to be relatively narrow. Accordingly, it is possible to inhibit the discharge from immediately stopping during the examination, thereby avoid failing to continue the examination of the battery pack 6.
(1-2) The voltage range of the second range A2 is set to be narrow, thereby to make it possible to expand the voltage range where the battery pack 6 is usable. Thus, it is possible to use the battery pack 6 effectively while protecting battery pack 6 appropriately.

### Second Embodiment

### 1. Difference from First Embodiment

A second embodiment has a basic configuration similar to that of the first embodiment and therefore, the description of the common configuration will be omitted, and the difference will be mainly described. The same reference numerals as those in the first embodiment indicate the same configuration, and reference is made to the preceding description.

In the interruption determination process of the above-described first embodiment, the range of the second range A2 varies depending on whether the electric work machine 10 is connected or not connected. In contrast, the second embodiment is distinct from the first embodiment in that the range of the second range A2 varies in accordance with the specification of the electric work machine 10 in the interruption determination process, in addition to the connection or non-connection of the electric work machine 10.

### 2. Interruption Determination Process

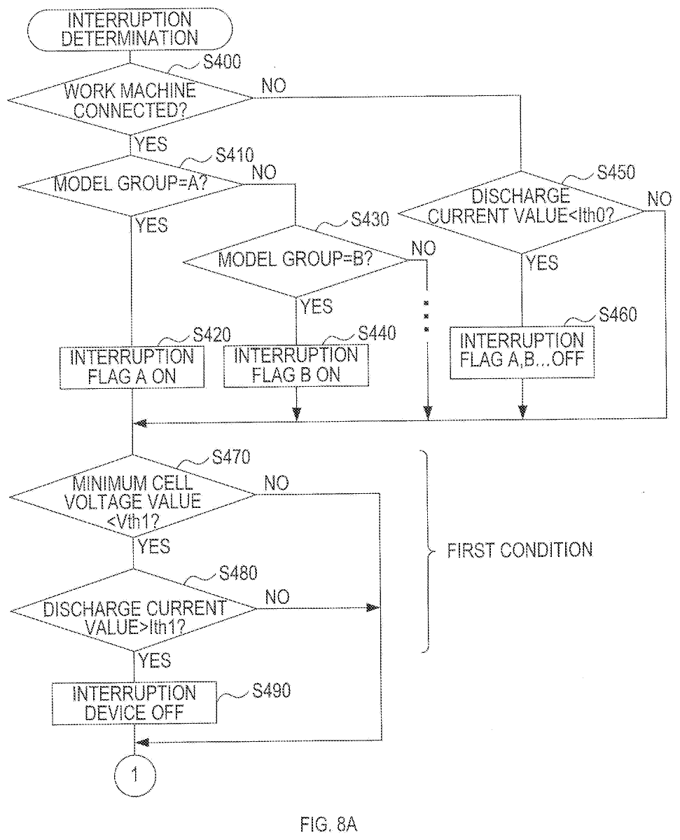

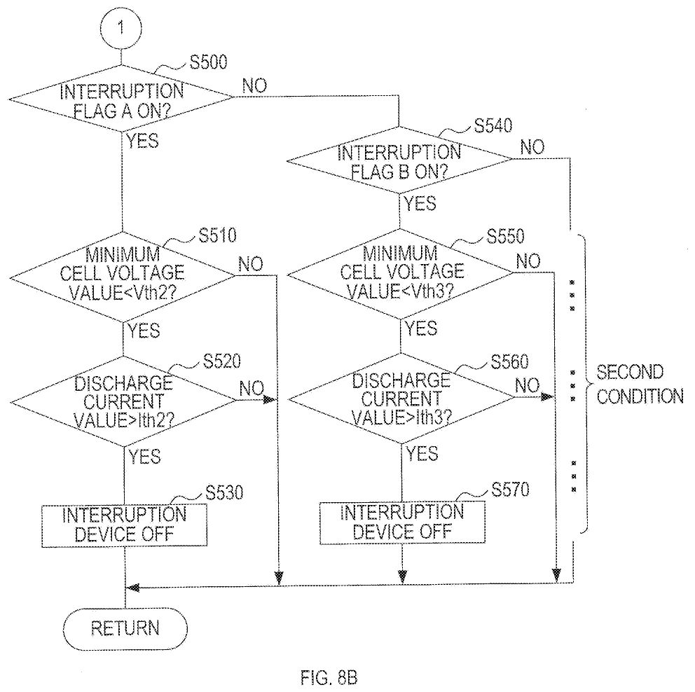

In the present embodiment, the battery MCU 150 executes the interruption determination process shown in FIGS. 8A and 8B, instead of the interruption determination process shown in FIG. 7.

First, in S400, the battery MCU 150 determines whether the electric work machine 10 is connected to the battery pack 6, based on the input signal from the first detection circuit 173. Also in the present embodiment, the battery MCU 150 varies the range of the second range A2 depending on whether the electric work machine 10 is connected or not connected, in a similar manner to the first embodiment.

In S400, if the battery MCU 150 determines that the electric work machine 10 is connected, the battery MCU 150 proceeds to S410. If the battery MCU 150 determines that the electric work machine 10 is not connected, battery MCU 150 proceeds to the S450.

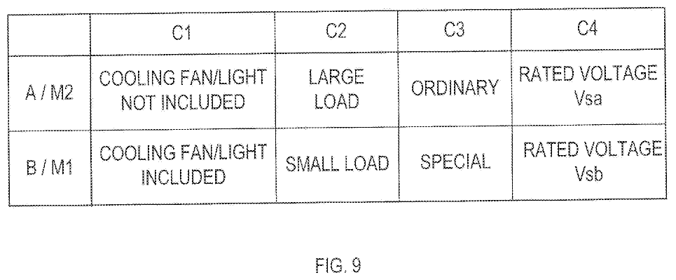

In S410, the battery MCU 150 determines whether the electric work machine 10 belongs to a model group A. As shown in FIG. 9, the battery MCU 50 classifies the electric work machine 10 as one of two or more model groups including the model group A and a model group B, in accordance with the specification of the electric work machine 10.

The specification of the electric work machine 10 includes whether the electric work machine 10 includes the cooling fan 281 and/or the light 280. Further, the specification of the electric work machine 10 includes a load of the electric work machine 10. The specification of the electric work machine 10 includes whether the electric work machine 10 is a special work machine including an actuator that performs the series of movements. The specification of the electric work machine 10 includes whether two or more battery blocks included in the battery 130 are connected in series or parallel. In another embodiment, at least one of these specifications of the electric work machine 10 may be removed from or another specification of the electric work machine may be added thereto.

In the present embodiment, the battery MCU 50 in a case where the electric work machine 10 belongs to the model group B sets the range of the second range A2 to be narrower than in the case where the electric work machine 10 belongs to the model group A, thereby to narrow the prohibition range AA. If the battery MCU 50 classifies the electric work machine 10 as one of three or more model groups, the battery MCU 50 sets, in the order of a model group C and a model group D, the prohibition range AA to be narrower.

Specifically, the electric work machine 10 without the cooling fan 281 and/or the light 280 is classified as the model group A, and the electric work machine 10 with the cooling fan 281 and/or the light 280 is classified as the model group B. If the electric work machine 10 does not include the cooling fan 281 and/or the light 280, the battery MCU 150 sets the voltage range of the second range A2 to be relatively large, thereby to relatively expand the prohibition range AA. If the electric work machine 10 includes the cooling fan 281 and/or the light 280, there may be desires, such as driving the cooling fan 281 for cooling an inside of the electric work machine 10 and illuminating the light 280 after the motor 270 is stopped. Accordingly, in this case, the battery MCU 150 sets the voltage range of the second range A2 to be relatively small, and thereby to relatively narrow the prohibition range AA. Thus, the battery MCU 150 allows the cooling fan 281 and/or the light 280 to be used after the motor 270 is stopped.

The electric work machine 10 with a relatively large load is classified as the model group A, and the electric work machine 10 with a relatively small load is classified as the model group B. If the load of the electric work machine 10 is relatively large, the battery MCU 150 sets the voltage range of the second range A2 to be relatively large, thereby to relatively expand the prohibition range AA. Thus, the battery MCU 150 enables the discharge to be interrupted immediately. On the other hand, if the load of the electric work machine 10 is relatively small, the necessity of protecting the battery pack 6 is low. Accordingly, in this case, the battery MCU 150 sets the voltage range of the second range A2 to be relatively narrow, thereby to relatively narrow the prohibition range AA. Thus, even if the cell voltage value is low, the battery MCU 150 allows the battery pack 6 to discharge.

If the electric work machine 10 is an ordinary work machine, the electric work machine 10 is classified as the model group A. If the electric work machine 10 is the special work machine, the electric work machine 10 is classified as the model group B. The ordinary work machine is a work machine, like the impact driver 10B, in which an actuator does not perform the series of movements. The special work machine is a work machine, like the pin tacker 10A, in which an actuator performs the series of movements. If the electric work machine 10 is the ordinary work machine, the battery MCU 150 sets the voltage range of the second range A2 to be relatively large, thereby to relatively expand the prohibition range AA. In the case where the electric work machine 10 is the special work machine, if the discharge stops during the actuator performing the series of movements, the actuator stops midway through the series of movements, thus decreasing the operation efficiency. Accordingly, in this case, the battery MCU 150 sets the voltage range of the second range A2 to be relatively narrow, thereby to relatively narrow the prohibition range AA. Thus, the battery MCU 150 inhibits the discharge from stopping during the actuator performing the series of movements.

If a rated voltage of the electric work machine 10 is Vsa, the battery MCU 150 classifies the electric work machine 10 as the model group A. If the rated voltage of the electric work machine 10 is Vsb, the battery MCU 150 classifies the electric work machine 10 as the model group B. The rated voltage Vsa is twice as the rated voltage Vsb. The rated voltage Vsa is, for example, 36V, and the rated voltage Vsb is, for example, 18V.

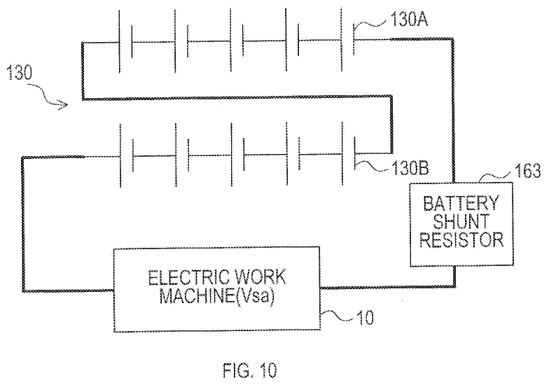

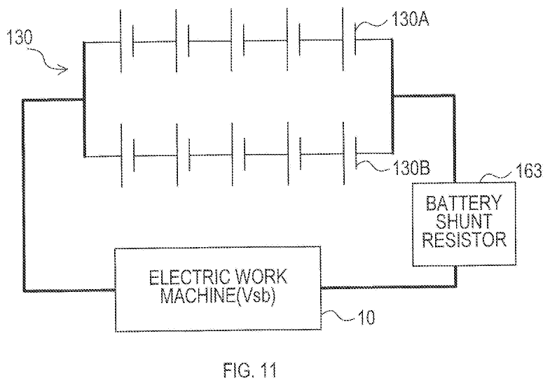

As shown in FIG. 10 and FIG. 11, the battery 130 includes a first battery block 130A and a second battery block 130B. If the battery MCU 150 receives, by serial communication, that the rated voltage is Vsa as the specification of the electric work machine 10, the first battery block 130A is connected in series to the second battery block 130B, as shown in FIG. 10. On the other hand, if the battery MCU 150 receives, by serial communication, that the rated voltage is Vsb as the specification of the electric work machine 10, the first battery block 130A is connected in parallel to the second battery block 130B, as shown in FIG. 11. In either case of the connection in parallel and in series, the discharge current flowing through the battery shunt resistor 163 is equal. However, the value of the discharge current flowing through each battery cell in the case of the connection in parallel is half of the value of the discharge current flowing through each battery cell in the case of the connection in series.

Accordingly, if the rated voltage of the electric work machine 10 is Vsa, the battery MCU 150 sets the current range of the second range A2 to be relatively large, thereby to relatively expand the prohibition range AA. On the other hand, if the rated voltage of the electric work machine 10 is Vsb, the battery MCU 150 sets the current range of the second range A2 to be relatively narrow, thereby to relatively narrow the prohibition range AA.

In S410, if the battery MCU 150 determines that the electric work machine 10 belongs to the model group A, the battery MCU 150 proceeds to S420. In S420, the battery MCU 150 sets the interruption flag A to ON, and sets the second voltage threshold Vth2 and second current threshold Ith2 corresponding to the second range A2 that is set relatively large.

On the other hand, in S410, if the battery MCU 150 determines that the electric work machine 10 does not belong to the model group A, the battery MCU 150 proceeds to S430. In S430, the battery MCU 150 determines whether the electric work machine 10 belongs to the model group B. If the battery MCU 150 determines that the electric work machine 10 belongs to the model group B, the battery MCU 150 proceeds to S440. If the battery MCU 150 determines that the electric work machine 10 does not belong to the model group B, the battery MCU 150 determines whether the electric work machine 10 belongs to the model group C and the model group D in order, as in S410 and S430. Herein, the case where the electric work machine 10 belongs to the model group A or the model group B is described, and a description of cases where the electric work machine 10 belongs to a model group following the model group C is omitted.

In S440, the battery MCU 150 sets the interruption flag B to ON, and sets a third voltage threshold Vth3 and a third current threshold Ith3. The third voltage threshold Vth3 and third current threshold Ith3 correspond to the second range A2 that is set to be relatively narrow.

Further, in S450 and S460, the battery MCU 150 executes a process similar to that in S220 and S230. In S460, the battery MCU 150 sets all the interruption flags A, B . . . to OFF. The number of the interruption flag corresponds to the number of the model groups.

In S450, if the battery MCU 150 determines that the discharge current value is equal to or greater than the interruption threshold Ith0, the battery MCU 150 does not set the interruption flag.

Subsequently, in S470 and S480, the battery MCU 150 determines whether the first condition is satisfied, in the same manner as in S240 and S250. If the first condition is satisfied, the battery MCU 150 turns off the interruption device 162 in S490 to interrupt the establishment of the first positive electrode line 180.

Subsequently, in S500, the battery MCU 150 determines whether the interruption flag A is ON. If the battery MCU 150 determines that the interruption flag A is ON, the battery MCU 150 proceeds to S510. In S510 and S520, the battery MCU 150 determines whether the second condition is satisfied, in the same manner as in S280 and S290. If the second condition is satisfied, the battery MCU 150 turns off the interruption device 162 in S530 to interrupt the establishment of the first positive electrode line 180. If the second condition is not satisfied, the battery MCU 150 completes this subroutine and returns to S30.

On the other hand, if the battery MCU 150 determines in S500 that the interruption flag A is OFF, the battery MCU 150 proceeds to S540. In S540, the battery MCU 150 determines whether the interruption flag B is ON. If the battery MCU 150 determines that the interruption flag B is ON, the battery MCU 150 proceeds to S550. In S550 and S560, the battery MCU 150 determines whether the second condition is satisfied, using the third voltage threshold Vth3 and the third current threshold Ith3, instead of the second voltage threshold Vth2 and the second current threshold Ith2, in a similar manner to S280 and S290. If the second condition is satisfied, the battery MCU 150 turns off the interruption device 162 in S570 to interrupt the establishment of the first positive electrode line 180. If the second condition is not satisfied, the battery MCU 150 completes this subroutine and returns to S30.

If the battery MCU 150 determines in S540 that the interruption flag B is OFF, the battery MCU 150 determines an interruption flag C and an interruption flag D in order, to determines whether the second condition is satisfied. If all the interruption flags are OFF, then the battery MCU 150 completes this subroutine and returns to S30.

### 3. Effect

According to the second embodiment as described above, the following effects can be obtained in addition to the effects (1-1) to (1-2) of the above-described first embodiment.
(1-3) In a case where the load of the electric work machine 10 is relatively small, the necessity of protecting the battery pack 6 is lower than in the case where the load of the electric work machine 10 is relatively large. Accordingly, when the load of the electric work machine 10 is relatively small, it is possible to set the prohibition range AA to be relatively narrow, thereby to use the battery pack 6 more effectively.
(1-4) If the electric work machine 10 includes the actuator that performs the series of movements, the prohibition range AA can be set to be relatively narrow, so that it is possible to inhibit the actuator from stopping during the series of movements, thus inhibiting the operation efficiency from decreasing.
(1-5) If the electric work machine 10 includes the cooling fan 281 and/or the light 280, the prohibition range AA is set to be relatively narrow. Accordingly, even after a relatively large supply of electric power to the motor 270 is stopped, a relatively small supply of electric power to the cooling fan 281 and/or the light 280 is possible. Thus, even after an operation of the electric work machine 10 is stopped, the cooling fan 281 and/or the light 280 can be used.
(1-6) In a case where the first battery block 130A is connected in parallel to the second battery block 130B, the necessity of protecting the battery pack 6 is lower than in the case where the first battery block 130A is connected in series. Accordingly, in the case of the connection in parallel, the prohibition range AA is set to be relatively narrow, and thereby the battery pack 6 can be used more effectively.
(1-7) If the first battery block 130A is connected in parallel to the second battery block 130B, it is possible to expand the current range where the battery pack 6 is usable, thereby to use the battery pack 6 effectively while protecting the battery pack 6 appropriately.

### Third Embodiment

### 1. Difference from Third Embodiment

A third embodiment has a basic configuration similar to that of the first embodiment and therefore, the description of the common configuration will be omitted, and the difference will be mainly described. The same reference numerals as those in the first embodiment indicate the same configuration, and reference is made to the preceding description.

In the first embodiment, in the battery pack protection process, the battery MCU 150 executes the over-current protection and outputs the discharge prohibition signal to the electric work machine 10 if the discharge current value is equal to or greater than the current threshold. In contrast, the third embodiment is distinct from the first embodiment in that the battery MCU 150 determines the over-current state of the battery pack 6 based on an integrated value of discharge current values, and outputs the discharge prohibition signal if the battery pack 6 is in the over-current state. Further, the third embodiment is distinct from the first embodiment in that, even if the battery MCU 150 outputs the discharge prohibition signal but the discharge current continues to flow, then in addition the battery MCU 150 interrupts the establishment of the first positive electrode line 180.

### 2. Process

<2-1. Battery Pack Protection Process>

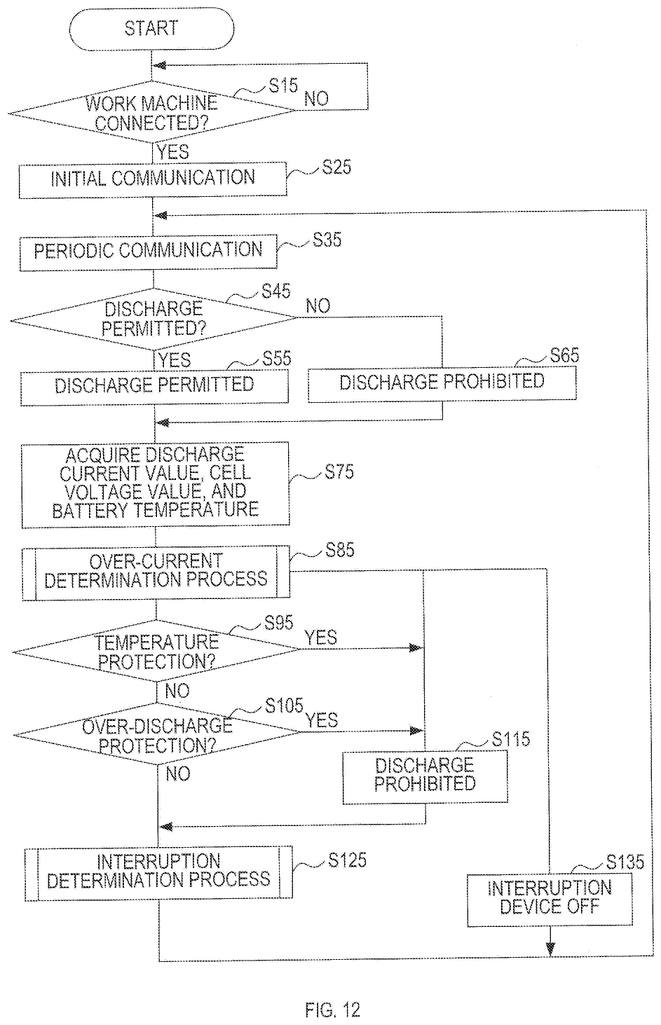

Next, a protection process for the battery pack 6 that is executed by the battery MCU 150 is described with reference to a flowchart of FIG. 12.

In S15, the battery MCU 150 determines the connection or non-connection of the electric work machine to the battery-side coupling portion 100, based on the input signal from the first detection circuit 173. That is, if the connection signal is input from the first detection circuit 173, the battery MCU 150 determines the connection of the electric work machine. If the non-connection signal is input from the first detection circuit 173, the battery MCU 150 determines the non-connection of the electric work machine. If an electric work machine that executes a corresponding regular control is connected to the battery pack 6, the first detection circuit 173 outputs the connection signal to the battery MCU 150. In a case where nothing is connected to the battery pack 6 or in a case where an electric work machine executing non-regular control that does not correspond to the battery pack 6 is connected, the first detection circuit 173 outputs the non-connection signal to the battery MCU 150. Accordingly, only in the case where a regular electric work machine is connected to the battery pack 6, the battery MCU 150 determines the connection of the electric work machine.

In S25 through S75, the battery MCU 150 executes those as in S20 through S70 in the flowchart shown in FIG. 6.

In S85, the battery MCU 150 executes an over-current determination process. The over-current determination process is described in details below.

In S95 through S125, the battery MCU 150 executes those as in S90 through S120 in the flowchart shown in FIG. 6. In the interruption determination process of S125, the interruption determination process of the first embodiment may be executed, or the interruption determination process of the second embodiment may be executed.

In S135, the interruption device 162 is turned off, and thus the establishment of the first positive electrode line 180 is interrupted. Accordingly, the discharge from the battery 130 stops.

<2-2. Over-Current Determination Process>

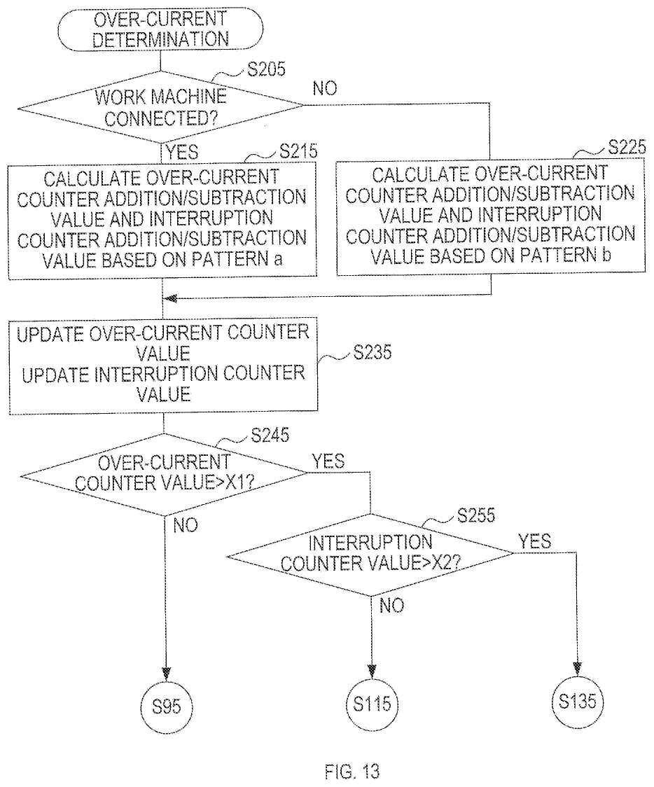

Next, the over-current determination process that is executed by the battery MCU 150 is described with reference to a subroutine of FIG. 13.

In S205, the battery MCU 150 determines the connection or non-connection of the electric work machine to the battery-side coupling portion 100, based on the input signal from the first detection circuit 173, as in S15. In S205, if the battery MCU 150 determines the connection of the electric work machine, the battery MCU 150 proceeds to S215, and if the battery MCU 150 determines the non-connection of the electric work machine, the battery MCU 150 proceeds to S225.

In S215, the battery MCU 150 calculates an over-current counter addition/subtraction value and an interruption counter addition/subtraction value based on the discharge current value detected by the battery shunt resistor 163 and correlation data of a pattern a.

In S225, the battery MCU 150 calculates the over-current counter addition/subtraction value and the interruption counter addition/subtraction value based on the discharge current value detected by the battery shunt resistor 163 and correlation data of a pattern b.

The correlation data includes a correspondence of the discharge current value and the over-current counter addition/subtraction value (hereinafter, over-current correlation data), and a correspondence of the discharge current value and the interruption counter addition/subtraction value (hereinafter, interruption correlation data). A memory 150b stores the over-current correlation data of the patterns a and b, and interruption correlation data of the patterns a and b in advance. In the present embodiment, each of the over-current counter addition/subtraction value and the interruption counter addition/subtraction value corresponds to one example of a counter addition/subtraction value of the present disclosure.

The battery MCU 150 repeatedly calculates the over-current counter addition/subtraction value in a preset cycle, and then integrates the calculated over-current counter addition/subtraction values, thereby to calculate an over-current counter value. Similarly, the battery MCU 150 repeatedly calculates the interruption counter addition/subtraction value in the preset cycle, and then integrates the calculated interruption counter addition/subtraction values, thereby to calculate an interruption counter value.

As will be described below, the battery MCU 150 determines whether the battery 130 is in the over-current state, based on the over-current counter value. If the battery MCU 150 determines that the battery 130 is in the over-current state, the battery MCU 150 prohibits the discharge of the battery 130. Further, the battery MCU 150 determines whether the discharge is continued after the discharge is prohibited, based on the interruption counter value. If the battery MCU 150 determines that the discharge is continued, the battery MCU 150 interrupts the discharge.

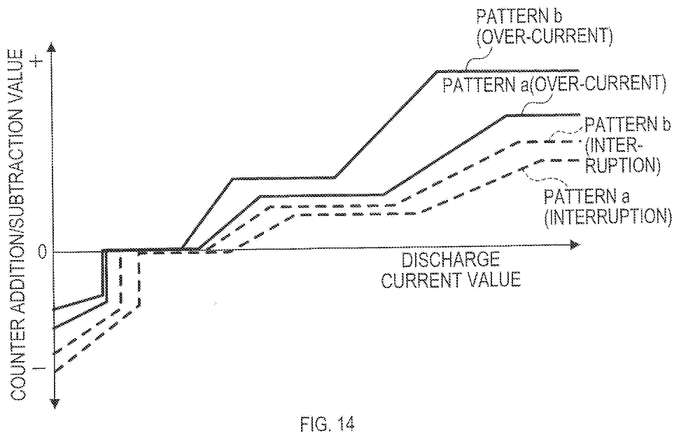

FIG. 14 shows a graph of the over-current correlation data of the patterns a and b, and the interruption correlation data of the patterns a and b. The patterns a correspond to the correlation data in the case where the connection of the electric work machine is determined. The patterns b correspond to the correlation data in the case where the non-connection of the electric work machine is determined. That is, the patterns a correspond to the correlation data in a case of a regular discharge, and the patterns b correspond to the correlation data in a case of an anomalous discharge.

The over-current counter addition/subtraction value includes a positive over-current counter addition value and a negative over-current counter subtraction value. The interruption counter addition/subtraction value includes a positive interruption counter addition value and a negative interruption counter subtraction value. The over-current counter addition value and the interruption counter addition value correspond to discharge current values equal to or greater than preset positions. The over-current counter subtraction value and the interruption counter subtraction value correspond to discharge current values less than preset values.

As described above, the over-current counter addition value of the pattern b is set to be greater than the over-current counter addition value in the pattern a such that an over-current determination on the battery pack 6 is immediately made and the battery pack 6 is protected. That is, in the same discharge current value, the over-current counter addition value of the pattern b is set to be greater than the over-current counter addition value of the pattern a. Similarly, in the same discharge current, the interruption counter addition value of the pattern b is set to be greater than the interruption counter addition value of the pattern a.

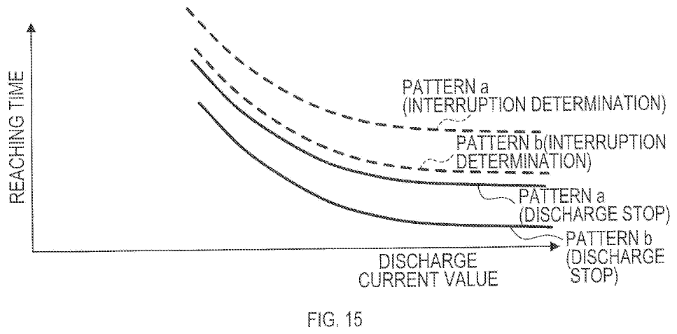

Accordingly, as shown in FIG. 15, in the same discharge current value, in the case where the non-connection of the electric work machine is determined, the over-current determination is made and the discharge is stopped, in an earlier time point than in the case where the connection of the electric work machine is determined. In addition, in the same discharge current value, in the case where the non-connection of the electric work machine is determined, the interruption determination is made in an earlier time point than in the case where the connection of the electric work machine is determined.

Further, a magnitude of the over-current counter subtraction value of the pattern b is set to be smaller than a magnitude of the over-current counter subtraction value of the pattern a, such that the over-current counter value gently decreases. That is, in the same the discharge current value, the magnitude the over-current counter subtraction value of the pattern b is set to be smaller than that of the over-current counter subtraction value of the pattern a. Similarly, in the same discharge current, a magnitude of the interruption counter subtraction value of the pattern b is set to be smaller than that of the interruption counter subtraction value of the pattern a.

In S235, the battery MCU 150 adds the over-current counter addition/subtraction value calculated in S215 or S225 to the over-current counter value, thereby to update the over-current counter value. In addition, the battery MCU 150 adds the interruption counter addition/subtraction value calculated in S215 or S225 to the interruption counter value, thereby to update the interruption counter value. In the present embodiment, each of the over-current counter value and the interruption counter value corresponds to one example of a counter value of the present disclosure.

Subsequently, in S245, the battery MCU 150 determines whether the over-current counter value is greater than a first threshold X1. If the battery MCU 150 determines that the over-current counter value is equal to or less than the first threshold X1, the battery MCU 150 proceeds to S95. If the battery MCU 150 determines that the over-current counter value is greater than the first threshold X1, the battery MCU 150 proceeds to S255.

In S255, the battery MCU 150 determines whether the interruption counter value is greater than a second threshold X2. The first threshold X1 and the second threshold X2 are set where time t1≤time t2 is satisfied. The time t1 corresponds to a time period from when the discharge starts until the over-current counter value reaches the first threshold X1. The time t2 corresponds to a time period from when the discharge starts until the over-current counter value reaches the second threshold X2. In FIG. 4, in the same pattern, the over-current counter addition/subtraction value is set to be greater than the interruption counter addition/subtraction value, but the present disclosure is not necessarily limited to this setting. If the relation of the time t1≤time t2 is established, the interruption counter addition/subtraction value may be set to be greater than the over-current counter addition/subtraction value, in the same pattern.

If the battery MCU 150 determines that the interruption counter value is equal to or less than the second threshold X2, the battery MCU 150 proceeds to S115. That is, if the battery MCU 150 determines that the battery 130 is in the over-current state, the battery MCU 150 proceeds to S115. In S115, the battery MCU 150 outputs the discharge prohibition signal to the electric work machine 10 through the first discharging control circuit 172 and the first discharge terminal 114, and prohibits the discharge.

If the battery MCU 150 determines that the interruption counter value is greater than the second threshold X2, the battery MCU 150 proceeds to S135. If the discharge stops due to the output of the discharge prohibition signal in S115, the interruption counter value decreases, so that the interruption counter value does not exceed the second threshold X2. If the discharge is continued regardless of the battery MCU 150 outputting the output of the discharge prohibition signal to the electric work machine 10, the interruption counter value exceeds the second threshold X2. In this case, the battery MCU 150 makes the interruption determination, the battery MCU 150 proceeds to S135. In S135, since the battery MCU 150 outputs the discharge prohibition signal but the discharge does not stop, the battery MCU 150 turns off the interruption device 162, thereby to interrupt the establishment of the first positive electrode line 180.

### 3. Effect

According to the third embodiment as described above, the following effects can be obtained.
(2-1) The battery pack 6 calculates the over-current counter addition/subtraction value and the interruption counter addition/subtraction value, based on the detected discharge current value and the correlation data that is selected depending on connection or non-connection of the electric work machine 10. In addition, the battery pack 6 calculates the over-current counter value and the interruption counter value based on the calculated over-current counter addition/subtraction value and the interruption counter addition/subtraction value, and prohibits the discharge from the battery 130 in response to the over-current counter value exceeding the first threshold XL. If the discharge is prohibited but the discharge is continued, the battery pack 6 interrupts the establishment of the first positive electrode line 180 in response to the interruption counter value exceeding the second threshold X2. Accordingly, it is possible to vary a time period from the discharge start to the discharge stop depending on the determined connection or non-connection of the electric work machine. Therefore, practical utility of the battery pack 6 can be improved.
(2-2) In the case where the non-connection of the electric work machine is determined, rates of increase of the over-current counter value and the interruption counter value become greater, and the discharge stops immediately, compared to the case where the connection of the electric work machine is determined. Accordingly, in the case where the battery pack 6 is not connected to the electric work machine 10 but is discharging, it is possible to stop the discharge promptly, thereby to protect the battery pack 6. Further, in a case where an electric work machine other than the electric work machine 10 that is in accordance with the regular control is connected to the battery pack 6, the connection of the electric work machine is not determined and the non-connection of the electric work machine is determined. Thus, even if any electric work machine is connected to the battery pack 6, unless the discharge in accordance with the regular control is performed, it is possible to stop the discharge promptly, thereby to protect the battery pack 6.
(2-3) In the case where non-connection of the electric work machine is determined, rates of decrease of the over-current counter value and the interruption counter value become smaller, compared to the case where the connection of the electric work machine is determined. Accordingly, in the case of the anomalous discharge of the battery pack 6, protection for a battery pack is more increased, compared to the case of the regular discharge of the battery pack 6.

### Fourth Embodiment

### 1. Difference from Third Embodiment

A fourth embodiment has a basic configuration similar to that of the third embodiment and therefore, the description of the common configuration will be omitted, and the difference will be mainly described. The same reference numerals as those in the third embodiment indicate the same configuration, and reference is made to the proceeding description.

In the above-described third embodiment, in the over-current determination process, the battery MCU 150 selects, depending on the connection determination or non-connection determination of the electric work machine, different over-current correlation data and interruption correlation data, thereby to calculate the over-current addition/subtraction value and interruption addition/subtraction value. In contrast, the fourth embodiment is distinct from the third embodiment in that the over-current addition/subtraction value and interruption addition/subtraction value are calculated in accordance with the specification of the electric work machine 10, in addition to the connection of the electric work machine determination or non-connection determination, in the over-current determination process.

### 2. Over-current Determination Process

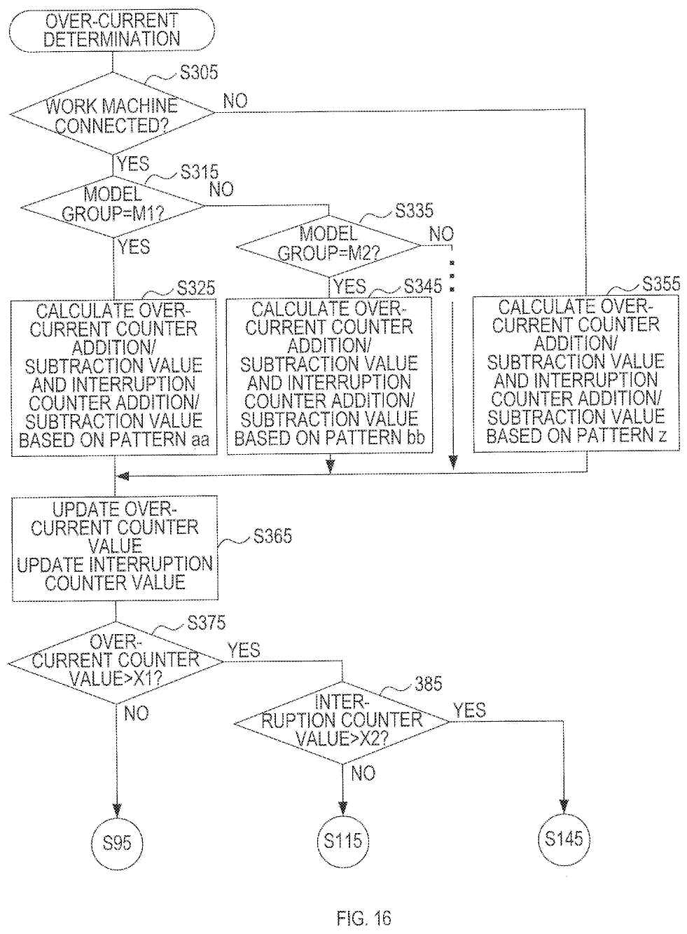

In the present embodiment, the battery MCU 150 executes an over-current determination process shown in FIG. 16, instead of the over-current determination process shown in FIG. 13.

First, in S305, the battery MCU 150 executes the same process as in S205. If the connection of the electric work machine is determined, the battery MCU 150 proceeds to S315. If the non-connection of the electric work machine is determined, the battery MCU 150 proceeds to S355. Also in the present embodiment, as in the third embodiment, the battery MCU 150 selects, depending on the connection determination or non-connection determination of the electric work machine, different over-current correlation data and interruption correlation data.

In S315, the battery MCU 150 determines whether the electric work machine 10 belongs to a model group M1. Also in the present embodiment, as in the second embodiment, the battery MCU 50 classifies the electric work machine 10 as one of two or more model groups including the model group M1 and a model group M2 in accordance with the specification of the electric work machine 10, as shown in FIG. 9. The model group M1 corresponds to the model group B, and the model group M2 corresponds to the model group A.

If the battery MCU 150 determines that the electric work machine 10 belongs to the model group M1, the battery MCU 150 proceeds to S325. If the battery MCU 150 determines that the electric work machine 10 does not belong to the model group M2, the battery MCU 150 proceeds to S335. In S335, the battery MCU 150 determines whether the electric work machine 10 belongs to the model group M2. If the battery MCU 150 determines that the electric work machine 10 belongs to the model group M2, the battery MCU 150 proceeds to S345. If the battery MCU 150 determines that the electric work machine 10 does not belong to the model group M2, the battery MCU 150 determines whether the electric work machine 10 belongs to a model group M3 and a model group M4 in order, as in S315 and S335. Herein, the case where the electric work machine 10 belongs to the model group M1 or the model group M2 is described, and a description of the cases where the electric work machine 10 belongs to a model group following the model group M3 is omitted.

In S325, the battery MCU 150 calculates the over-current counter addition/subtraction value and the interruption counter addition/subtraction value, based on correlation data of a pattern aa and on the discharge current value that is detected by the battery shunt resistor 163.

In S345, the battery MCU 150 calculates the over-current counter addition/subtraction value and the interruption counter addition/subtraction value, based on correlation data of a pattern bb and on the discharge current value that is detected by the battery shunt resistor 163.

In S355, the battery MCU 150 calculates the over-current counter addition/subtraction value and the interruption counter addition/subtraction value, based on correlation data of a pattern z and on the discharge current value that is detected by the battery shunt resistor 163.

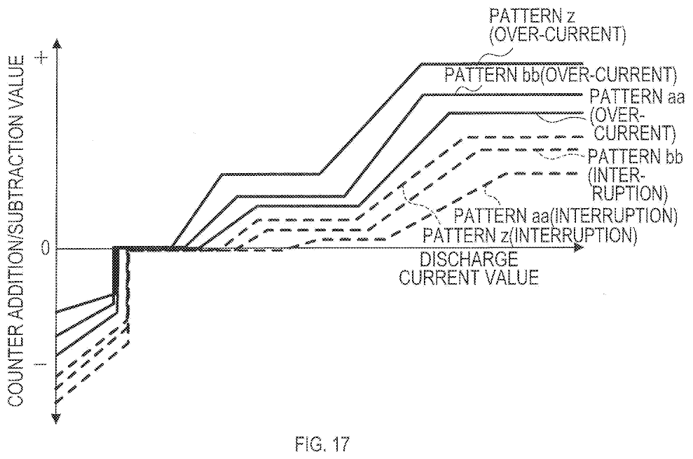

FIG. 17 shows a graph of over-current correlation data of the patterns aa, bb, and z, and interruption correlation data of the patterns aa, bb, and z. The memory 150b stores the over-current correlation data of the patterns aa, bb, and z, and interruption correlation data of the patterns aa, bb, and z, in advance. If the patterns aa correspond to the correlation data in the case where the electric work machine 10 belongs to the model group M1. The patterns bb correspond to the correlation data in the case where the electric work machine 10 belongs to the model group M2. The patterns z correspond to the correlation data in the case where the non-connection of the electric work machine 10 is determined.

The electric work machine 10 belonging to the model group M2 has higher necessity of protecting the battery pack 6 than the electric work machine 10 belonging to the model group M1. Accordingly, as shown in FIG. 17, in the same discharge current value, the over-current counter addition value of the pattern bb is set to be greater than the over-current counter addition value of the pattern aa. Similarly, in the same discharge current, the interruption counter addition value of the pattern bb is set to be greater than the interruption counter addition value of the pattern aa. Further, in the same discharge current value, a magnitude of the over-current counter subtraction value of the pattern bb is set to be smaller than that of the over-current counter subtraction value of the pattern aa. Similarly, in the same discharge current, a magnitude of the interruption counter subtraction value of the pattern bb is set to be smaller than that of the interruption counter subtraction value of the pattern aa.

Also in the case where the electric work machine 10 belongs to either the model group M1 or M2, the battery pack 6 performs the regular discharge. Accordingly, in the case where the non-connection of the electric work machine 10 is determined, necessity of protecting the battery pack 6 is higher than in the case where the electric work machine 10 belonging to the model group M2 is connected the battery pack 6. Thus, as shown in FIG. 17, in the same discharge current value, the over-current counter addition value of the pattern z is set to be greater than the over-current counter addition value of the pattern bb. Similarly, in the same discharge current, the interruption counter addition value of the pattern z is set to be greater than the interruption counter addition value of the pattern bb. Further, in the same discharge current value, a magnitude of the over-current counter subtraction value of the pattern z is set to be smaller than a magnitude of the over-current counter subtraction value of the pattern bb. Similarly, in the same discharge current, a magnitude of the interruption counter subtraction value of the pattern z is set to be smaller than the magnitude of the interruption counter subtraction value of the pattern bb.

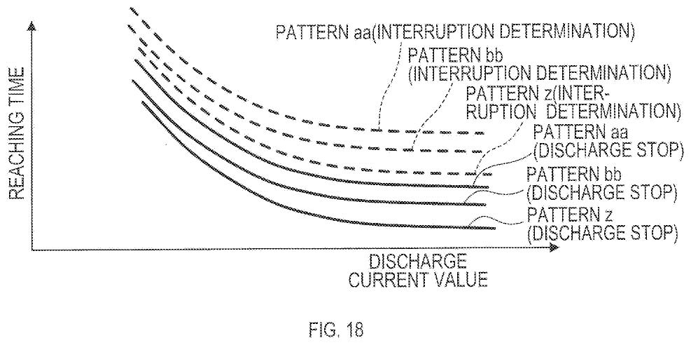

As shown in FIG. 18, in the same discharge current value, in the case the electric work machine 10 belonging to the model group M2 is connected to the battery pack 6, the over-current determination is made and the discharge is stopped in an earlier time point and the interruption determination is made in an earlier time point, than in the case where the electric work machine 10 belonging to the model group M1 is connected to the battery pack 6. In addition, in the same discharge current value, in the case where the non-connection of the electric work machine is determined, the over-current determination is made and the discharge is stopped in an earlier time point and the interruption determination is made in an earlier time point, than in the case where the electric work machine 10 belonging to the model group M2 is connected to the battery pack 6.

Subsequently, in S365 through S385, the battery MCU 150 executes the same processes in S235 through S255.

### 3. Effect

According to the fourth embodiment as described above, the following effects can be obtained in addition to the effects (2-1) to (2-3).
(2-4) The battery MCU 150 calculates the over-current counter addition/subtraction value and the interruption counter addition/subtraction value, based on the detected discharge current value and on the correlation data selected in accordance with the specification of the electric work machine 10 connected to the battery pack 6. Accordingly, the time period from the discharge start to the discharge stop is variable in accordance with the specification of the electric work machine 10 connected to the battery pack 6, in addition to the determined connection or non-connection of the electric work machine. Therefore, practical utility of the battery pack 6 can be improved.
(2-5) The specification of the electric work machine 10 includes the load of the electric work machine 10, and thereby different correlation data are selected in accordance with the load of the electric work machine. Accordingly, practical utility of the battery pack 6 can be improved.
(2-6) Different correlation data are selected depending on whether the electric work machine 10 includes an actuator that executes a series of movements. Accordingly, practical utility of the battery pack 6 can be improved.
(2-7) Different correlation data are selected depending on whether the electric work machine 10 includes a cooling fan and/or a light. Accordingly, practical utility of the battery pack 6 can be improved.
(2-8) Different correlation data are selected depending on whether the first battery block 130A and the second battery block 130B are connected in series or in parallel. Accordingly, practical utility of the battery pack 6 can be improved.
(2-9) In a case where the load of the electric work machine 10 connected to the battery pack 6 is high, rates of increase of the over-current counter value and the interruption counter value become greater than in the case where the load is small, so that it is possible to stop the discharge promptly, thereby to protect the battery pack 6.
(2-10) In a case where the load of the electric work machine 10 connected to the battery pack 6 is high, rates of decrease of the over-current counter value and the interruption counter value become smaller than in the case where the load is small, so that it is possible to increase protection of the battery pack 6.
(2-11) In the case where the non-connection of the electric work machine is determined, than in the case where the load of the electric work machine 10 that is connected is high, rates of increase of the over-current counter value and the interruption counter value become greater, and thereby the discharge stops promptly. Accordingly, in the case of anomalous discharge of the battery pack 6, it is possible to increase protection of the battery pack 6 more than in the case where the load of the electric work machine 10 connected to the battery pack 6 is high.

### Other Embodiments

Although the embodiments for implementing the present disclosure have been described above, the present disclosure is not limited the aforementioned embodiments, and various modifications can be made.
(a) In the first and second embodiments, the prohibition range AA where the battery pack 6 prohibits itself from discharging is variable but a range where the battery pack 6 prohibits the electric work machine 10 from discharging is constant; however, the present disclosure is not limited thereto. That is, a range of the discharge current value in which the over-current protection is executed in S80, and/or a range of a discharge voltage value in which the over-discharge protection is executed in S100 are variable depending on the connection or non-connection of the electric work machine 10, and/or in accordance with the specification of the electric work machine 10.
(b) In the third and fourth embodiments, the battery MCU 150 calculates both of the over-current counter addition/subtraction value and the interruption counter addition/subtraction value based on correlation data, but may calculate only either one thereof. That is, the battery MCU 150 does not necessarily output the discharge prohibition signal based on the over-current counter value, nor switch the interruption device 162 to OFF based on the interruption counter value, and may execute only either one thereof.
(c) In place of or in addition to the microcomputer, the battery MCU 150 and the work machine MCU 250 do not necessarily have to be MCU and may be provided with a combination of various electronic components, Application Specified Integrated Circuit (ASIC), Application Specific Standard Product (ASSP), a programmable logic device such as Field Programmable Gate Array (FPGA), and a combination thereof.
(d) Two or more functions of a single element in the embodiments described above may be achieved by two or more elements, and a single function of a single element may be achieved by two or more elements. Two or more functions of two or more elements may be achieved by a single element, and a single function achieved by two or more elements may be achieved by a single element. Further, a part of the configurations described above may be omitted. Furthermore, at least a part of the configurations described above may be added to or replaced with another configuration described above.

1-13. (canceled)

14. A battery pack, comprising:
a battery;
a coupling portion configured to be connected to an electric work machine;
a line that connecting the battery to the coupling portion;
an interruption device (i) arranged in the line and (ii) configured to complete the line or interrupt the line;
a detection circuit configured (i) to detect connection or non-connection of the electric work machine to the coupling portion, and (ii) to output a signal indicating the connection or the non-connection;
a measurement circuit configured to measure an output voltage value of the battery and a discharge current value of the battery, the output voltage value corresponding to a magnitude of an output voltage of the battery, the discharge current value corresponding to a magnitude of a current flowing from the battery; and
a controller programmed to:
detect the connection or the non-connection based on the signal output from the detection circuit,
narrow a prohibition range in a case of determining the non-connection, more than in a case of determining the connection, the prohibition range being defined by a range of the output voltage value and by a range of the discharge current value, and
interrupt the line through the interruption device based on (i) the output voltage value measured and (ii) the discharge current value measured falling within the prohibition range.

15. A battery pack, comprising:
a battery;
a coupling portion configured to be connected to an electric work machine;
a connection detector configured to detect connection or non-connection of the electric work machine to the coupling portion;
a receiver configured to receive work machine information from the electric work machine connected to the coupling portion, the work machine information including a specification of the electric work machine; and
a controller configured to:
vary a prohibition range based on (i) the connection or non-connection that is detected by the connection detector, or (ii) the specification that is received by the receiver, the prohibition range being defined by a range of an output voltage value and by a range of an discharge current value, the output voltage value corresponding to a magnitude of an output voltage of the battery, the discharge current value corresponding to a magnitude of a current flowing from the battery, and
prohibit the battery from discharging based on (i) the output voltage value and (ii) the discharge current value falling within the prohibition range.

16. The battery pack according to claim 15,
wherein the specification includes a load of the electric work machine.

17. The battery pack according to claim 15,
wherein the specification includes whether the electric work machine includes a first actuator, the first actuator being configured to perform a series of movements, the series of movements corresponding to the first actuator moving from a first position to a second position and returning from the second position to the first position.

18. The battery pack according to claim 17,
wherein the first position corresponds to an initial position of the first actuator, and
wherein the second position corresponds to a position at which the first actuator has a maximum amount of displacement from the initial position.

19. The battery pack according to claim 15,
wherein the specification includes whether the electric work machine includes a cooling fan and/or a light.

20. The battery pack according to claim 15,
wherein the battery includes a first battery block and a second battery block, the first battery block being configured to be connected in series or in parallel to the second battery block in accordance with the electric work machine connected to the coupling portion, and
wherein the specification includes whether the first battery block is connected in series to the second battery block, or connected in parallel to the second battery block.

21. The battery pack according to claim 15,
wherein the controller is configured to vary the prohibition range based on the connection or the non-connection that is detected by the connection detector.

22. The battery pack according to claim 16,
wherein the controller is configured to vary the prohibition range based on the load.

23. The battery pack according to claim 17,
wherein the controller is configured to vary the prohibition range based on whether the electric work machine includes the first actuator.

24. The battery pack according to claim 19,
wherein the controller is configured to vary the prohibition range based on whether the electric work machine includes a cooling fan and/or a light.

25. The battery pack according to claim 20,
wherein the controller is configured to vary the prohibition range based on whether the first battery block is connected in series or in parallel to the second battery block.

26. The battery pack according to claim 21,
wherein the controller is configured to narrow the prohibition range in a case where the non-connection is detected by the connection detector, more than in a case where the connection is detected by the connection detector.

27. The battery pack according to claim 22,
wherein the controller is configured to narrow the prohibition range in a case where the load is small, more than in a case where the load is large.

28. The battery pack according to claim 23,
wherein the controller is configured to narrow the prohibition range in a case where the electric work machine includes the first actuator, more than in a case where the electric work machine does not include the first actuator.

29. The battery pack according to claim 24,
wherein the controller is configured to narrow the prohibition range in a case where the electric work machine includes the cooling fan and/or the light, more than in a case where the electric work machine include neither the cooling fan nor the light.

30. The battery pack according to claim 25,
wherein the controller is configured to narrow the prohibition range in a case where the first battery block is connected in parallel to the second battery block, more than in a case where the first battery block is connected in series to the second battery block.

31. The battery pack according to claim 26,
wherein the prohibition range includes a first range and a second range, the discharge current value in the second range being smaller than that in the first range, the range of the discharge current value in the second range being adjacent to the range of the discharge current value in the first range, and
wherein the controller is configured to fix the first range and narrow the range of the output voltage value in the second range, thereby to narrow the prohibition range.

32. The battery pack according to claim 30,
wherein the prohibition range includes a first range and a second range, the discharge current value in the second range being smaller than that in the first range, the range of the discharge current value in the second range being adjacent to the range of the discharge current value in the first range, and
wherein the controller is configured to fix the first range and narrow the range of the discharge voltage value in the second range, thereby to narrow the prohibition range.

33. A method of controlling a discharge of a battery pack, the method comprising:
detecting connection or non-connection of an electric work machine to a coupling portion of the battery pack;
receiving work machine information from the electric work machine connected to the coupling portion, the work machine information including a specification of the electric work machine;
varying a prohibition range based on (i) the connection or the non-connection of that is detected, or (ii) the specification that is received, the prohibition range being defined by a range of an output voltage value and by a range of an discharge current value, the output voltage value corresponding to a magnitude of an output voltage of the battery, the discharge current value corresponding to a magnitude of a current flowing from the battery; and
prohibiting the battery from discharging based on (i) the output voltage value and (ii) the discharge current value.
